(19) United States
(12) Patent Application Publication
(10) Pub. No.: US 2010/0254463 A1
(43) Pub. Date: Oct. 7, 2010

(54) IMAGE CODING METHOD, IMAGE DECODING METHOD, IMAGE CODING APPARATUS, IMAGE DECODING APPARATUS, SYSTEM, PROGRAM, AND INTEGRATED CIRCUIT

(75) Inventors: Matthias Narroschke, Rodgau-Dudenhofen (DE); Steffen Wittmann, Moerfelden-Walldorf (DE); Thomas Wedi, Gross-Urnstadt (DE); Youji Shibahara, Osaka (JP)

Correspondence Address: WENDEROTH, LIND & PONACK L.L.P., 1030 15th Street, N.W., Suite 400 East, Washington, DC, 20005-1503, US

(73) Assignee: PANASONIC CORPORATION, Osaka (JP)

(21) Appl. No.: 12/740,551

(22) PCT Filed: Sep. 4, 2009
(86) PCT No.: PCT/JP2009/004386

§ 371 Date: Apr. 29, 2010

(30) Foreign Application Priority Data
Sep. 4, 2008 (EP) 08015661.5

(51) Int. Cl. H04N 7/26

(52) U.S. Cl. 375/240.29; 375/E07.193

(57) ABSTRACT

An image coding method includes: quantizing a signal to be coded to determine a quantized coefficient (S11); inverse quantizing the quantized coefficient to generate a decoded signal (S12); subdividing the decoded signal into image areas (S13); estimating (i) first correlation data for each area larger than one of the image areas determined in the subdividing, and (ii) second correlation data for each of the image areas determined in the subdividing, the first correlation data indicating a correlation between the signal to be coded and the decoded signal, and the second correlation data indicating an autocorrelation of the decoded signal (S14); calculating a filter coefficient using the first and second correlation data for each of the image areas (S15); filtering the decoded signal for each of the image areas, using the filter coefficient calculated in the calculating; and providing only the first correlation data from the first and second correlation data.

### TECHNICAL FIELD

The present invention relates to a method and an apparatus for coding and decoding video using adaptive filters for filtering video signals.

### BACKGROUND ART

At present, the majority of standardized video coding algorithms are based on hybrid video coding. Hybrid video coding methods typically combine several different lossless and lossy compression schemes in order to achieve a desired compression gain. Hybrid video coding is also the basis for ITU-T standards (H.26x standards such as H.261 and H.263) as well as ISO/IEC standards (MPEG-X standards such as MPEG-1, MPEG-2, and MPEG-4). The most recent and advanced video coding standard is currently the standard denoted as H.264/MPEG-4 advanced video coding (AVC) which is a result of standardization efforts by joint video team (JVT), a joint team of ITU-T and ISO/IEC MPEG groups.

A video signal input to a video coding apparatus is a sequence of images called frames (or pictures), and each frame is a two-dimensional matrix of pixels. All the above-mentioned standards based on the hybrid video coding include subdividing each individual video frame into smaller blocks each including a plurality of pixels. Typically, a macroblock (usually denoting a block of 16×16 pixels) is the basic image element, for which the coding is performed. However, various particular coding steps may be performed for smaller image elements, such as blocks or subblocks each having the size of, for instance, 8×8, 4×4, and 16×8.

Typically, the coding steps of the hybrid video coding include a spatial and/or a temporal prediction. Accordingly, each block to be coded is first predicted using either the blocks in its spatial neighbourhood or blocks from its temporal neighbourhood, i.e. from previously coded video frames. A block of differences between a block to be coded and its prediction, also called prediction residuals, is then calculated. Another coding step is a transformation of a block of residuals from the spatial (pixel) domain into a frequency domain. The transformation aims at reducing the redundancies in the input block. The next coding step is quantization of the transform coefficients. In this step, the actual lossy (irreversible) compression takes place. Usually, the compressed transform coefficient values are further compacted (losslessly compressed) by means of an entropy coding. In addition, side information necessary for reconstruction of a coded video signal is coded and provided together with the coded video signal. The side information is, for example, information about the spatial and/or temporal prediction, and an amount of quantization.

FIG. 1 is an example of a typical H.264/AVC standard compliant video coding apparatus 100. The H.264/AVC standard combines all above-mentioned coding steps. A subtractor 105 first determines differences between a current block (block to be coded) of a video image (input signal) and a corresponding predicted block (prediction signal).

A temporally predicted block is a block from the previously coded image which is stored in a memory 140. A spatially predicted block is interpolated from pixel values of boundary pixels in the neighbouring blocks which have been previously coded and stored in the memory 140. The memory unit 140 thus operates as a delay unit that allows a comparison between current signal values and values of the prediction signal generated from previous signal values. The memory 140 can store a plurality of previously coded video frames.

The difference between the input signal and the prediction signal, denoted as prediction error or residuals, is then transformed and quantized by a transform quantization unit 110. An entropy coding unit 190 entropy codes (also referred to as “variable length codes” hereinafter) the quantized coefficients in order to further reduce the amount of data in a lossless way. More specifically, the reduction is achieved by the entropy coding with code words of variable length wherein the length of a code word is determined based on the probability of occurrence of values.

The H.264/AVC includes two functional layers, a Video Coding Layer (VCL) and a Network Abstraction Layer (NAL). The VCL provides the coding functionality as briefly described above. The NAL encapsulates the coded data together with the side information necessary for the decoding thereof into standardized units called NAL units according to their further application (transmission over a channel, storing in a storage unit). There are VCL NAL units containing the compressed video data and the related information.

There are also non-VCL units encapsulating additional data such as a parameter set relating to an entire video sequence, or recently added Supplemental Enhancement Information (SEI) providing additional information that can be used to improve the decoding performance such as post filter hint.

The video coding apparatus 100 includes a decoding unit for obtaining a decoded video signal. In compliance with the coding steps, the decoding steps include an inverse quantization/inverse transformation unit 120. The decoded prediction error signal differs from the original input signal due to the quantization error, called also quantization noise. An adder 125 adds the decoded prediction error signal to a prediction signal to obtain a reconstructed signal. In order to maintain the compatibility between the video coding apparatus side and the video decoding apparatus side, the prediction signal is obtained based on the coded and subsequently decoded video signals which are known by both of the sides.

Due to the quantization, the quantization noise is superposed to the reconstructed video signal. Due to coding per block, the superposed noise often has blocking characteristics, which result, in particular for strong quantization, in visible block boundaries in the decoded image. Such blocking artifacts have a negative effect upon human visual perception. In order to reduce these artifacts, a deblocking filter 130 is applied to every reconstructed image block. The deblocking filter 130 is applied to the reconstructed signal which is a sum of the prediction signal and the decoded prediction error signal. The video signal after deblocking is the decoded signal which is generally displayed at the video decoding apparatus side (if no post filtering is applied). The deblocking filter 130 in H.264/AVC has the capability of local adaptation. In the case of a high degree of blocking noise, a strong (narrow-band) low pass filter is applied, whereas for a low degree of blocking noise, a weaker (broad-band) low pass filter is applied. The deblocking filter 130 generally smoothes the block edges leading to an improved subjective quality of the decoded images. Moreover, since the filtered part of an image is used for the motion compensated prediction of further images, the filtering also reduces the prediction errors, and thus enables improvement of coding efficiency. The decoded signal is then stored in the memory 140.

The prediction signal in H.264/AVC is obtained either by a temporal or by a spatial prediction. The type of prediction can be varied on a per macroblock basis. Macroblocks predicted using the temporal prediction are called inter-coded macroblocks, and macroblocks predicted using the spatial prediction are called intra-coded macroblocks. Here, the term “inter” relates to inter-picture prediction, i.e. prediction using information from previous or following frames. The term “intra” refers to the spatial prediction which only uses the already coded information within the current video frame. The type of prediction for a video frame can be set by the user or selected by the video coding apparatus 100 so as to achieve a possibly high compression gain. In accordance with the selected type of prediction, an intra/inter switch 175 provides a corresponding prediction signal to the subtractor 105.

Intra-coded images (called also I-type images or I frames) consist solely of macroblocks that are intra-coded, i.e. intra-coded images can be decoded without reference to any other previously decoded image. The intra-coded images provide error resilience for the coded video sequence since they refresh the video sequence from errors possibly propagated from frame to frame due to temporal prediction. Moreover, I frames enable a random access within the sequence of coded video images.

Intra-fame prediction uses a predefined set of intra-prediction modes which basically predict the current macroblock using the boundary pixels of the neighboring macroblocks already coded. The different types of spatial prediction refer to a different edge direction, i.e. the direction of the applied two-dimensional interpolation. The prediction signal obtained by such interpolation is then subtracted from the input signal by the subtractor 105 as described above. In addition, spatial prediction type information is entropy coded and signalized together with the coded video signal.

In order to decode inter-coded images, the inter-coded images require images previously coded and subsequently decoded. Temporal prediction may be performed uni-directionally, i.e., using only video frames ordered in time before the current frame to be coded, or bi-directionally, i.e., using also video frames following the current frame. The uni-directional temporal prediction results in inter-coded images called P frames; and the bi-directional temporal prediction results in inter-coded images called B frames. In general, an inter-coded image includes any of P-, B-, or even I-type macroblocks.

An inter-coded macroblock (P- or B-macroblock) is predicted by employing a motion compensated prediction unit 160. First, the motion compensated prediction unit 160 detects a best-matching block for the current block within previously coded and decoded video frames. The best-matching block then becomes a prediction signal, and the relative displacement (motion) between the current block and the best-matching block is then signalized as motion data in the form of two-dimensional motion vectors within the side information provided together with the coded video data.

In order to optimize prediction accuracy, motion vectors may be determined with a sub-pixel resolution e.g. half pixel or quarter pixel resolution. A motion vector with sub-pixel resolution may point to a position within an already decoded frame where no real pixel value is available, i.e. a sub-pixel position. Hence, spatial interpolation of such pixel values is needed in order to perform motion compensation. The interpolation is achieved by an interpolation filter 150. According to the H.264/AVC standard, a six-tap Wiener interpolation filter with fixed filter coefficients and a bilinear filter are applied in order to obtain pixel values for sub-pixel positions.

For both the intra- and the inter-coding modes, the transform quantization unit 110 transforms and quantizes the differences between the current input signal and the prediction signal, resulting in the quantized transform coefficients. Generally, an orthogonal transformation such as a two-dimensional discrete cosine transformation (DCT) or an integer version thereof is employed since it reduces the redundancies of the natural video images efficiently. Lower frequency components are usually more important for image quality than high frequency components so that more bits can be spent for coding the low frequency components than the high frequency components.

After quantization, a two-dimensional array of quantized coefficients is converted into a one-dimensional array thereof to be transmitted to the entropy coding unit 190. Typically, this conversion is performed by so-called zig-zag scanning, which starts in the upper left corner of the two-dimensional array and scans the two-dimensional array in a predetermined sequence ending the lower right corner. As the energy is typically concentrated in the left upper part of the image corresponding to the lower frequencies, the zig-zag scanning results in an array where usually the last values are zero. This allows for efficient coding using run-length codes as a part of/before the actual entropy coding.

In order to improve the image quality, a post filter 280 may be applied to a video decoding apparatus 200. The H.264/AVC standard allows sending post filter information for such the post filter 280 via a Supplemental Enhancement Information (SEI) message. The post filter information is determined by the video coding apparatus 100 side by means of a post filter design unit 180 which compares a locally decoded signal and an original input signal. The output of the post filter design unit 180 is also fed to the entropy coding unit 190 in order to be coded and inserted into the coded signal. The entropy coding unit 190 employs variable length codes that differ in lengths depending on different type of information to be coded in order to adapt to the statistic thereof.

FIG. 2 illustrates an example of the video decoding apparatus 200 compliant with the H.264/AVC video coding standard. The coded video signal (input signal to the video decoding apparatus) first passes to an entropy decoding unit 290 which decodes the quantized coefficients, the information elements necessary for decoding such as motion data, type of prediction etc., and the post filter information. The quantized coefficients are inversely scanned in order to obtain a two-dimensional array which is then fed to an inverse quantization/inverse transformation unit 220. After inverse quantization and inverse transformation by the inverse quantization/inverse transformation unit 220, a decoded (quantized) prediction error signal is obtained, which corresponds to the differences obtained by subtracting the prediction signal from the signal input to the video coding apparatus 100.

The prediction signal is obtained from either a motion compensated prediction unit (temporal prediction unit) 260 or an intra-frame prediction unit (spatial prediction unit) 270 which is switched by an intra/inter switch 275 in accordance with a received information element for signalizing the prediction applied to the video coding apparatus 100.

The decoded information elements further include information necessary for predicting a prediction type in the case of intra-prediction, and motion data in the case of motion compensated prediction, for example. Depending on the current value of the motion vector, interpolation of pixel values may be needed in order to perform the motion compensated prediction. The interpolation is performed by an interpolation filter 250.

The quantized prediction error signal in the spatial domain is then added by means of an adder 225 to the prediction signal obtained either from the motion compensated prediction unit 260 or the intra-frame prediction unit 270. The reconstructed image may be passed to a deblocking filter 230 and the resulting decoded signal is stored in the memory 240 to be applied for temporal or spatial prediction of the following blocks.

The post filter information is fed to the post filter 280, and accordingly, the post filter 280 is set up. The post filter 280 is then applied to the decoded signal in order to further improve the image quality. Thus, the post filter 280 is capable of adapting to the properties of a video signal entering the video coding apparatus 100 on a per-frame basis.

In summary, there are three types of filters used in the latest standard H.264/AVC: an interpolation filter, a deblocking filter, and a post filter. In general, the suitability of a filter depends on the image to be filtered. Therefore, a filter design capable of adapting to the image characteristics is advantageous. The filter coefficients of such a filter may be designed as Wiener filter coefficients.

The latest standard H.264/AVC applies a separable and fixed interpolation filter. However, there are proposals to replace the separable and fixed interpolation filter by an adaptive one either separable or non-separable, such as, for instance, S. Wittmann, T. Wedi, “Separable adaptive interpolation filter (Non Patent Literature 1)”, ITU-T Q.6/SG16, doc. T05-SG16-C-0219, Geneva, Switzerland, June 2007. The current H.264/AVC standard furthermore allows the use of an adaptive post filter. For this purpose, the post filter design unit 180 estimates a post filter for each image as described above. The post filter design unit 180 generates filter information (referred to as post filter hint) which is transmitted to the video decoding apparatus 200 in the form of an SEI message. The post filter 280 may use the filter information that is applied to the decoded signal before displaying the image. Filter information that is transmitted from the video coding apparatus 100 to the video decoding apparatus 200 can either be filter coefficients or a cross correlation vector. Transmitting side information may improve the quality of filtering, but, on the other hand, requires additional bandwidth. Using the transmitted or calculated filter coefficients, the entire image is post filtered. The deblocking filter in H.264/AVC is used as a loop filter to reduce blocking artifacts at block edges. All three types of filter may be estimated as a Wiener filter.

FIG. 3 illustrates a signal flow using a Wiener filter 300 for noise reduction. Noise n is added to an input signal s, resulting in a noise signal s′ to be filtered. With the goal of reducing the noise n, the Wiener filter 300 is applied to the signal s′, resulting in the filtered signal s″. The Wiener filter 300 is designed to minimize the mean square error between the input signal s that is a desired signal, and the filtered signal s″. This means that Wiener filter coefficients w correspond to the solution of optimization problem arg_{w} min E[(s−s″)²] which can be formulated as a system of linear equations called Wiener-Hopf equations. The solution is given by the following Equation 1.

w=R⁻¹·p [Equation 1]

Here, w is an M×1 vector containing the optimal coefficients of Wiener filter having order M, M being a positive integer. R⁻¹ denotes the inverse of an M×M autocorrelation matrix R of the noise signal s′ to be filtered. p denotes an M×1 cross correlation vector between the noise signal s′ to be filtered and the original signal s. Further details on adaptive filter design can be found in S. Haykin, “Adaptive Filter Theory (Non Patent Literature 2)”, Fourth Edition, Prentice Hall Information and System Sciences Series, Prentice Hall, 2002, which is incorporated herein by reference.

### CITATION LIST

### [Patent Literature]

### [Non Patent Literature]

### [NPL 1]

Separable adaptive interpolation filter (S. Wittmann, T. Wedi, ITU-T Q.6/SG16, doc. T05-SG16-C-0219, Geneva, Switzerland, June 2007)

### [NPL 2]

Adaptive Filter Theory (S. Haykin, Prentice Hall Information and System Sciences Series, Prentice Hall, 2002)

### SUMMARY OF INVENTION

### Technical Problem

Thus, one of the advantages of the Wiener filter 300 is that the filter coefficients can be determined from the autocorrelation of the corrupted (noise) signal and the cross correlation between the corrupted signal and the desired signal. As the filter coefficients are used to filter an image or a sequence of images, it is implicitly assumed that the image signal is at least wide-sense stationary, i.e. its first two statistic moments (mean, correlation) do not change in time. By applying such a filter on a non-stationary signal, its performance decreases considerably. Natural video sequences are in general not stationary. Video sequences are in general not stationary. Thus, quality of the filtered non-stationary images is reduced.

The object of the present invention is to provide a coding and decoding mechanism with adaptive filtering for video signals. The mechanism is capable of adapting to the local characteristics of the image and is efficient in terms of coding gain.

### Solution to Problem

The image coding method according to an aspect of the present invention is an image coding method of coding a signal to be coded that represents an image. More specifically, the method includes: quantizing the signal to be coded to determine a quantized coefficient; inverse quantizing the quantized coefficient to generate a decoded signal; subdividing the decoded signal into image areas; estimating (i) first correlation data for each area larger than one of the image areas determined in the subdividing, and (ii) second correlation data for each of the image areas determined in the subdividing, the first correlation data indicating a correlation between the signal to be coded and the decoded signal, and the second correlation data indicating an autocorrelation of the decoded signal; calculating a filter coefficient using the first correlation data and the second correlation data for each of the image areas; filtering the decoded signal for each of the image areas, using the filter coefficient calculated in the calculating; and providing only the first correlation data from the first correlation data and the second correlation data.

In the image coding method having the aforementioned configuration, the first correlation data that can be generated only by an image coding apparatus is generated for each of areas that are relatively larger, and the second correlation data that can be generated by both an image coding apparatus and an image decoding apparatus is generated for each of areas that are relatively smaller. As such, as the first correlation data is less frequently generated, the coding efficiency is improved. Furthermore, as the frequency of generating the second correlation data is improved, a more adaptive filter coefficient can be calculated.

In the calculating, the filter coefficient is calculated based on (i) a cross correlation vector between the signal to be coded and a coded signal and (ii) an autocorrelation matrix of the decoded signal, the cross correlation vector includes a first part indicating the autocorrelation of the decoded signal, and a second part indicating an autocorrelation of quantization noise, the first correlation data includes only the second part from the first part and the second part, and the second correlation data may include the first part and the autocorrelation vector. Thereby, the coding efficiency is further improved.

Furthermore, the image coding method is a method of subdividing the signal to be coded into blocks, and coding the subdivided signal to be coded for each of the blocks, and in the subdividing, the decoded signal may be subdivided into the image areas based on at least one of a quantization step size, a prediction type, and a motion vector that are determined for each of the blocks. Thereby, a more adaptive filter coefficient can be calculated.

Furthermore, at least one of a deblocking filter process, a loop filter process, and an interpolation filter process may be performed in the filtering, the deblocking filter process being for reducing blocking artifacts occurring in a boundary between the blocks that are adjacent to each other, the loop filter process being for improving a subjective image quality of the decoded signal, and the interpolation filter process being for spatially interpolating a pixel value of the decoded signal.

Furthermore, in the estimating, the first correlation data may be calculated for each of signals to be coded including the signal to be coded. Thereby, the coding efficiency is further improved.

Furthermore, the providing may include providing a coded signal by entropy coding the quantized coefficient and the first correlation data.

The image decoding method according to an aspect of the present invention is an image decoding method of decoding a coded signal. More specifically, the method includes: obtaining a quantized coefficient, and first correlation data indicating a correlation between a signal to be coded and a decoded signal; inverse quantizing the quantized coefficient to generate the decoded signal; subdividing the decoded signal into image areas; estimating second correlation data for each of the image areas determined in the subdividing, the second correlation data indicating an autocorrelation of the decoded signal; calculating a filter coefficient for each of the image areas using the first correlation data and the second correlation data; and filtering the decoded signal for each of the image areas, using the filter coefficient calculated in the calculating.

Furthermore, at least one of a deblocking filter process, a post filter process, and an interpolation filter process may be performed in the filtering, the deblocking filter process being for reducing blocking artifacts occurring in a boundary between the blocks that are adjacent to each other, the post filter process being for improving a subjective image quality of the decoded signal, and the interpolation filter process being for spatially interpolating a pixel value of the decoded signal.

The image coding apparatus according to an aspect of the present invention codes a signal to be coded that represents an image. More specifically, the apparatus includes: a quantization unit configured to quantize the signal to be coded to determine a quantized coefficient; an inverse quantization unit configured to inverse quantize the quantized coefficient to generate a decoded signal; an area forming unit configured to subdivide the decoded signal into image areas; an estimation unit configured to estimate (i) first correlation data for each area larger than one of the image areas determined by the area forming unit, and (ii) second correlation data for each of the image areas determined by the area forming unit, the first correlation data indicating a correlation between the signal to be coded and the decoded signal, and the second correlation data indicating an autocorrelation of the decoded signal; a filter coefficient calculation unit configured to calculate a filter coefficient using the first correlation data and the second correlation data for each of the image areas; a filtering unit configured to filter the decoded signal for each of the image areas, using the filter coefficient calculated by the filter coefficient calculation unit; and an output unit configured to provide only the first correlation data from the first correlation data and the second correlation data.

The image decoding apparatus according to an aspect of the present invention decodes a coded signal. More specifically, the apparatus includes: an obtaining unit configured to obtain a quantized coefficient, and first correlation data indicating a correlation between a signal to be coded and a decoded signal; an inverse quantization unit configured to inverse quantize the quantized coefficient to generate the decoded signal; an area forming unit configured to subdivide the decoded signal into image areas; an estimation unit configured to estimate second correlation data for each of the image areas determined by the area forming unit, the second correlation data indicating an autocorrelation of the decoded signal; a filter coefficient calculation unit configured to calculate a filter coefficient for each of the image areas using the first correlation data and the second correlation data; and a filtering unit configured to filter the decoded signal for each of the image areas, using the filter coefficient calculated by the filter coefficient calculation unit.

The system according to an aspect of the present invention includes: an image coding apparatus that codes a signal to be coded that represents an image; and an image decoding apparatus that decodes a coded image, the image coding apparatus including: a quantization unit configured to quantize the signal to be coded to determine a quantized coefficient; an inverse quantization unit configured to inverse quantize the quantized coefficient to generate a decoded signal; an area forming unit configured to subdivide the decoded signal into image areas; an estimation unit configured to estimate (i) first correlation data for each area larger than one of the image areas determined by the area forming unit, and (ii) second correlation data for each of the image areas determined by the area forming unit, the first correlation data indicating a correlation between the signal to be coded and the decoded signal, and the second correlation data indicating an autocorrelation of the decoded signal; a filter coefficient calculation unit configured to calculate a filter coefficient using the first correlation data and the second correlation data for each of the image areas; a filtering unit configured to filter the decoded signal for each of the image areas, using the filter coefficient calculated by the filter coefficient calculation unit; and an output unit configured to provide only the first correlation data from the first correlation data and the second correlation data, and the image decoding apparatus including: an obtaining unit configured to obtain a quantized coefficient, and the first correlation data indicating the correlation between the signal to be coded and the decoded signal; an inverse quantization unit configured to inverse quantize the quantized coefficient to generate the decoded signal; an area forming unit configured to subdivide the decoded signal into image areas; an estimation unit configured to estimate second correlation data for each of the image areas determined by the area forming unit, the second correlation data indicating an autocorrelation of the decoded signal; a filter coefficient calculation unit configured to calculate a filter coefficient for each of the image areas using the first correlation data and the second correlation data; and a filtering unit configured to filter the decoded signal for each of the image areas, using the filter coefficient calculated by the filter coefficient calculation unit.

The program according to an aspect of the present invention causes a computer to code a signal to be coded that represents an image. More specifically, the program includes: quantizing the signal to be coded to determine a quantized coefficient; inverse quantizing the quantized coefficient to generate a decoded signal; subdividing the decoded signal into image areas; estimating (i) first correlation data for each area larger than one of the image areas determined in the subdividing, and (ii) second correlation data for each of the image areas determined in the subdividing, the first correlation data indicating a correlation between the signal to be coded and the decoded signal, and the second correlation data indicating an autocorrelation of the decoded signal; calculating a filter coefficient using the first correlation data and the second correlation data for each of the image areas; filtering the decoded signal for each of the image areas, using the filter coefficient calculated in the calculating; and providing only the first correlation data from the first correlation data and the second correlation data.

The program according to an aspect of the present invention causes a computer to decode a coded signal. More specifically, the program includes: obtaining a quantized coefficient, and first correlation data indicating a correlation between a signal to be coded and a decoded signal; inverse quantizing the quantized coefficient to generate the decoded signal; subdividing the decoded signal into image areas; estimating second correlation data for each of the image areas determined in the subdividing, the second correlation data indicating an autocorrelation of the decoded signal; calculating a filter coefficient for each of the image areas using the first correlation data and the second correlation data; and filtering the decoded signal for each of the image areas, using the filter coefficient calculated in the calculating.

The intergraded circuit according to an aspect of the present invention codes a signal to be coded that represents an image. More specifically, the intergraded circuit includes: a quantization unit configured to quantize the signal to be coded to determine a quantized coefficient; an inverse quantization unit configured to inverse quantize the quantized coefficient to generate a decoded signal; an area forming unit configured to subdivide the decoded signal into image areas; an estimation unit configured to estimate (i) first correlation data for each area larger than one of the image areas determined by the area forming unit, and (ii) second correlation data for each of the image areas determined by the area forming unit, the first correlation data indicating a correlation between the signal to be coded and the decoded signal, and the second correlation data indicating an autocorrelation of the decoded signal; a filter coefficient calculation unit configured to calculate a filter coefficient using the first correlation data and the second correlation data for each of the image areas; a filtering unit configured to filter the decoded signal for each of the image areas, using the filter coefficient calculated by the filter coefficient calculation unit; and an output unit configured to provide only the first correlation data from the first correlation data and the second correlation data.

The intergraded circuit according to an aspect of the present invention decodes a coded signal. More specifically, the intergraded circuit includes: an obtaining unit configured to obtain a quantized coefficient, and first correlation data indicating a correlation between a signal to be coded and a decoded signal; an inverse quantization unit configured to inverse quantize the quantized coefficient to generate the decoded signal; an area forming unit configured to subdivide the decoded signal into image areas; an estimation unit configured to estimate second correlation data for each of the image areas determined by the area forming unit, the second correlation data indicating an autocorrelation of the decoded signal; a filter coefficient calculation unit configured to calculate a filter coefficient for each of the image areas using the first correlation data and the second correlation data; and a filtering unit configured to filter the decoded signal for each of the image areas, using the filter coefficient calculated by the filter coefficient calculation unit.

The present invention can be implemented not only as an image coding method (apparatus) and an image decoding method (apparatus) but also as an integrated circuit for implementing functions thereof and as a program for causing a computer to execute such functions. Obviously, such a program can be distributed via recording media, such as a CD-ROM, and via transmission media, such as the Internet.

Preferred embodiments are the subject matter of the dependent claims.

According to a method unique to the present invention, a filter for filtering a decoded video signal is designed in a locally adaptive manner using an image coding apparatus and/or an image decoding apparatus. First, image areas are determined using a video signal, and a filter coefficient is calculated using statistic information such as a correlation. The first part of the correlation information is associated with a video signal to be coded and a decoded video signal. Thus, the image coding apparatus side determines the first part and provides it to the image decoding apparatus side. The second part of the correlation information is associated with the decoded video signal, and the image coding apparatus and/or the image decoding apparatus estimate(s) the second part locally, that is, for each of the image areas.

The method enables adapting a filter to the local characteristics of video images (frames), thus improving a resulting image quality. Furthermore, there are cases where the signaling overhead is reduced by estimating a local part of the statistic information using the image decoding apparatus.

According to a first aspect of the present invention, provided is a method of coding an input video signal including at least one video frame. The input video signal is coded, and the coded video signal is decoded. Moreover, image areas are determined in a video frame of the decoded video signal. Next, the first correlation data that is information for calculating a filter coefficient is determined, based on the input video signal and the decoded video signal. The second correlation data is estimated for each of the image areas based on the decoded video signal. The first correlation data is provided to the image decoding apparatus side to derive a filter coefficient for filtering the image areas. The filter coefficient is calculated based on the first correlation data and the second correlation data. Each of the image areas is filtered using the calculated filter coefficient.

According to another aspect of the present invention, provided is a method of decoding a coded video signal including at least one video frame. The coded video signal is decoded to obtain the first correlation data. The image coding apparatus determines the first correlation data based on a video signal processed by the image coding apparatus side. Moreover, image areas are derived in a video frame of the decoded video signal, and the second correlation data for each of the determined image areas is estimated based on the decoded video signal. The determined image areas are filtered, and a filter coefficient to be used for filtering the determined image areas is calculated based on the first correlation data and the second correlation data.

According to another aspect of the present invention, provided is an apparatus that codes an input video signal including at least one video frame. The apparatus includes a video coding device that codes an input video signal, a video decoding device that decodes the coded video signal, and a first estimation unit that determines first correlation data for calculating a filter coefficient using the input video signal and the decoded video signal. The apparatus is capable of providing the first correlation data to the video decoding device. The apparatus further includes the following constituent elements. More specifically, the apparatus includes: an image area forming unit that determines image areas included in a video frame of a video signal; a second estimation unit that estimates a second correlation data based on the decoded video signal for each of the image areas; a filter that filters the image areas; and a coefficient calculation unit that calculates a filter coefficient using the first correlation data and the second correlation data.

According to another aspect of the present invention, provided is a method of decoding a coded video signal including at least one video frame. The apparatus includes a video decoding device that decodes the coded video signal, and is capable of obtaining the first correlation data determined by the video coding device, based on the video signal processed by the video coding device. The apparatus further includes the following constituent elements. More specifically, the apparatus includes: an image area forming unit that determines image areas included in a video frame of a video signal; a second estimation unit that estimates second correlation data based on the decoded video signal for each of the image areas; a filter that filters the image areas; and a coefficient calculation unit that calculates a filter coefficient using the first correlation data and the second correlation data.

According to an embodiment of the present invention, the first correlation data includes an estimate of a second statistic moment, such as a cross correlation vector between an input video signal and a decoded video signal. The information may be advantageously used for calculating a filter coefficient. The decoded video signal is a video signal obtained after any decoding step. For example, the decoding step includes inverse quantization, inverse transformation, obtaining a reconstructed video signal by summing up residuals and a prediction signal, and filtering.

The coded video signal is in general a sum of the input video signal and the noise causing degradation of the input signal. There are cases where noise occurs in a coding step. Thus, a cross correlation vector may be separated in parts including, for example, a part only related to a coded video signal, a part only related to a noise signal, or a part related to both the part only related to a coded video signal and the part only related to a noise signal. According to a preferred embodiment of the present invention, the first correlation data includes an estimate of a part of a cross correlation vector between an input video signal and a decoded video signal. Since the video decoding device cannot derive the information, a part of a cross correlation vector related to a noise signal is preferably provided to the video decoding device (the noise signal indicates a difference between a decoded video signal and a video signal to be coded, that is, an input signal to a video coding device). The noise signal is, for example, quantization noise that is one of coding steps and that occurs in quantization of a video signal. The first correlation data may be an autocorrelation of the quantization noise. The second correlation data includes a part of a cross correlation vector that can be estimated by the video decoding device, and relates only to a decoded video signal. The second correlation data includes an autocorrelation matrix of the decoded video signal.

With the knowledge of the autocorrelation matrix of the decoded video signal and the cross correlation vector between an input video signal and the corresponding decoded video signal, a filter coefficient can be calculated. According to a preferred embodiment of the present invention, a filter coefficient is calculated in accordance with a Wiener filter i.e. as a product of the inverse autocorrelation matrix and the cross correlation vector.

The filter can be applied after any of the decoding steps. Preferably, the filtering is performed in a spatial domain on the reconstructed video signal. However, in case of hybrid video coding, the filtering may be applied, for instance, to decoded residuals (prediction error signal), to a reconstructed video signal after summing up the residuals and the prediction signal, or to a filtered reconstructed video signal.

Preferably, the first correlation data is provided per video frame, while the second statistic information is estimated locally, i.e. per image area. Alternatively, the first correlation data may also be estimated and provided per image area. Providing the first correlation data for each image area allows for more precise calculation of a first filter coefficient. Thus, the calculation leads to improved quality of an image after filtering especially for the cases with non stationary relation between the input video signal and noise. However, it also increases the bandwidth necessary for transmission of coded video data and thus reduces the coding efficiency. Other solutions for estimating and providing the first correlation data are possible, such as providing the first information per set of image areas within one or a plurality of video frames.

According to another preferred embodiment of the present invention, the image areas are determined based on information signalized together with the video signal within the coded video data, for instance, a type of prediction, a spatial prediction type, motion vectors, and a quantization step size. Deriving the image areas from the generically signalized information requires low complexity, and can be performed in the same manner by the video coding device and the video decoding device. Consequently, no additional signaling information is necessary. Alternatively, the image areas can be derived based on information determined from the decoded video signal. For example, predefined values of the autocorrelation matrix of a coded video signal or any function of the autocorrelation matrix values may be used. Such deriving of the image areas may be more flexible than relying on the signalized information and may better suit the desired application, namely, determining the image areas with similar statistical characteristics. However, the image areas may also be arbitrarily determined by the video coding device, and the information describing the image areas may be provided together with the second statistic information to the video decoding device. Based on this information, the video decoding device derives the image areas. Such approach of deriving the image areas provides the highest flexibility.

Preferably, each of the image areas includes one or more image elements such as blocks or macroblocks used at different stages of video coding. However, the image areas may be independent of the image subdivision performed by the video coding device and the video decoding device in various steps of coding and decoding, respectively. The size and shape of the image areas depend also on the manner in which the image areas are derived.

In a preferred embodiment of the present invention, the filter coefficient of at least one of a loop filter, a post filter, an interpolation filter, and a deblocking filter is calculated based on the first and the second correlation data. In general, such a locally adaptive filter according to an implementation of the present invention may be a loop filter. In other words, a result of the filtering is stored in a memory and may be used in further coding steps, such as prediction. Furthermore, a post filter may be applied to the reconstructed signal after decoding.

The first correlation data is stored in a storage unit and then provided, extracted from the storage unit and then obtained, or transmitted and received over a transmission channel together with the coded video signal within the coded video data. In particular, the first statistic information can be entropy coded in order to reduce the bandwidth necessary for its storing or transmitting. Any other coding may also be used, including forward error protection.

According to a preferred embodiment of the present invention, the video signal is coded and decoded in accordance with the H.264/AVC standard. In particular, the first correlation data is provided within the Supplemental Enhancement Information (SEI) message. However, the present invention is applicable to any other video coding and decoding standards using filtering. For instance, any standardized coding and decoding methods based on hybrid coding can be used, such as MPEG-X, H.26X, JPEG 2000, Dirac or their enhancements as well as non-standardized (proprietary) coding and decoding methods.

According to a preferred embodiment of the present invention, a computer program product including a computer-readable medium having a computer-readable program code embodied thereon is provided, the program code being adapted to implement the present invention.

According to yet another aspect of the present invention, a system for transferring a video signal from a video coding device to a video decoding device is provided. The system includes the video coding device as described above, a channel for storing or transmitting a coded video signal, and the video decoding device as described above. According to an embodiment of the present invention, the channel corresponds to a storing medium, for instance, a volatile or a non-volatile memory, an optic or a magnetic storing medium such as CD, DVD, BD or a hard disc, a Flash memory, or any other storing means. According to another embodiment of the present invention, the channel is a transmission medium. The channel can be formed by resources of a wireless or a wired system, or any combination of both in accordance with any standardized or proprietary transmission technology/system such as Internet, WLAN, UMTS, ISDN, and xDSL.

The above and other objects and features of the present invention will become more apparent from the following description and preferred embodiments given in conjunction with the accompanying drawings.

### Advantageous Effects of Invention

The present invention improves the coding efficiency and enables an adaptive filter process by reducing the frequency of calculation of the first correlation data transferred from an image coding apparatus to an image decoding apparatus and more frequently calculating the second correlation data that can be calculated by both the video coding apparatus and the video decoding apparatus.

### BRIEF DESCRIPTION OF DRAWINGS

FIG. 1 is a block diagram of a conventional video coding apparatus.

FIG. 2 is a block diagram of a conventional video decoding apparatus.

FIG. 3 is a schematic drawing illustrating Wiener filter design.

FIG. 4A is a schematic drawing illustrating an example of image subdivision into blocks before coding.

FIG. 4B is a schematic drawing illustrating an example of image areas with different sizes and shapes according to an implementation of the present invention.

FIG. 5A is a block diagram of a video coding apparatus according to an implementation of the present invention.

FIG. 5B shows a flowchart of the video coding apparatus illustrated in FIG. 5A.

FIG. 6A is a block diagram of a video decoding apparatus according to an implementation of the present invention.

FIG. 6B shows a flowchart of the video decoding apparatus illustrated in FIG. 6A.

FIG. 7 illustrates a coding system using a Wiener post filter for noise reduction.

FIG. 8 illustrates a coding system using a Wiener post filter for noise reduction.

FIG. 9 illustrates an example when an image is subdivided into local areas where L=3.

FIG. 10 is a block diagram of a video coding apparatus including a loop filter according to an embodiment of the present invention.

FIG. 11 is a block diagram of a video decoding apparatus including a post filter according to an embodiment of the present invention.

FIG. 12 is a block diagram of a video coding apparatus including an interpolation filter according to another embodiment of the present invention.

FIG. 13 is a block diagram of a video decoding apparatus including an interpolation filter according to another embodiment of the present invention.

FIG. 14 schematically illustrates a system including a video coding apparatus and a video decoding apparatus according to an implementation of the present invention.

FIG. 15 illustrates an overall configuration of a content providing system for implementing content distribution services.

FIG. 16 illustrates a cellular phone that uses the image coding method and the image decoding method according to each of Embodiments in the present invention.

FIG. 17 is a block diagram of the cellular phone in FIG. 16.

FIG. 18 illustrates an overall configuration of a digital broadcasting system.

FIG. 19 is a block diagram illustrating an example of a configuration of a television.

FIG. 20 is a block diagram illustrating an example of a configuration of an information reproducing/recording unit that reads and writes information from and on a recording medium that is an optical disk.

FIG. 21 illustrates an example of a configuration of a recording medium that is a disk.

FIG. 22 is a block diagram illustrating an example of a configuration of an integrated circuit for implementing the video coding method and the video decoding method according to each of Embodiments.

### DESCRIPTION OF EMBODIMENTS

The problem underlying the present invention is based on observation that images of a video sequence, in particular of a natural video sequence, are non-stationary, i.e. their statistics vary. Therefore, applying a same filter to an entire image may result in a suboptimal performance in terms of quality of the reconstructed image.

In order to solve this problem, the present invention provides a method of coding and decoding, an apparatus for coding and an apparatus for decoding of a video signal, as well as a system for transferring a coded video signal from a video coding apparatus side to a video decoding apparatus side. Furthermore, the present invention provides a program and an integrated circuit for implementing these methods.

In the methods, the apparatuses, and the system, filtering is performed in a locally adaptive manner, and is controlled by correlation data estimated per image area which is a part of a video frame. Here, the correlation data is based on a decoded video signal. In addition, for calculating the filter coefficients, correlation data determined at the video coding apparatus side is used, based on the decoded video signal and on a video signal only available at the video decoding apparatus side. This correlation data is provided to the video decoding apparatus side. The degree of local adaptability and the image quality after filtering depend on the size and shape of the image area(s) for which the filtering is performed as well as on a method of determining the image area.

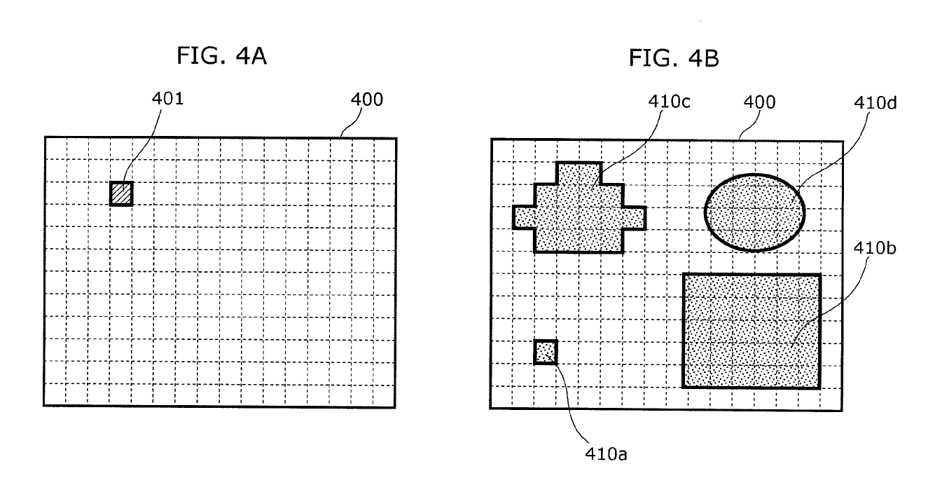

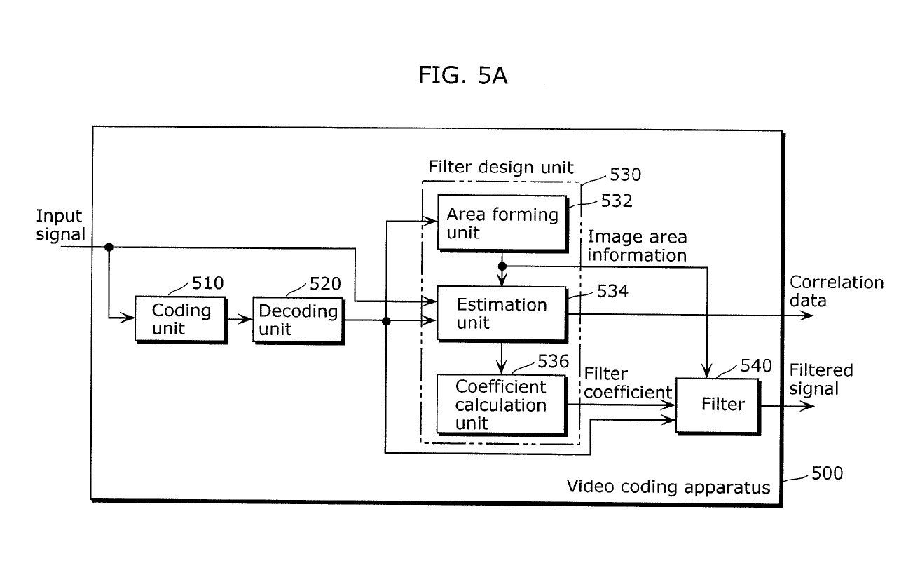

FIG. 4A illustrates subdivision of a video frame 400 into a plurality of blocks 401. The subdivision is typically performed after coding. In case of H.264/AVC coding, the image is subdivided into a plurality of 16×16 mackroblocks, which are further subdivided into subblocks of 4×4 or 8×8 pixels for the transformation, or to subblocks of 4×4, 8×8, 16×8, etc. for the temporal prediction.

FIG. 4B illustrates four examples of image areas according to an implementation of the present invention. An image area here refers to a part of a video frame (picture). In general, such image area may align to the underlying subdivision to image elements performed in one of the coding steps as illustrated in FIG. 4A.

Thus, an example image area 410a corresponds to a macroblock, or to a block used in one of the standardized coding steps. Another example image area 410b includes several macroblocks or blocks organized in a rectangular shape. A further example image area 410c includes a plurality of blocks or macroblocks organized in an arbitrary shape. The image area may also correspond to a slice when slicing is applied by the video coding apparatus such as, for instance, in H.264/AVC standard. A yet further example image area 410d has an arbitrary shape and includes a plurality of image samples. In other words, an image area is not necessarily aligned to the underlying image subdivision performed by the video coding apparatus.

An image area may also be formed by a single image pixel (a basic image element). The illustrated example image areas 410a, 410b, 410c and 410d are all continuous, meaning that each pixel has at least one neighbor pixel from the same image area. However, the present invention is also applicable to image areas which are not continuous. The suitability of particular shapes and sizes of image areas according to an implementation of the present invention is determined by the content of the video frame and a method of determining an image area as described hereinafter.

### Embodiment 1

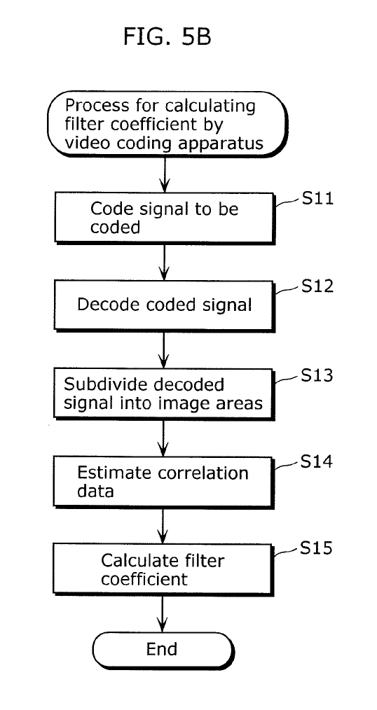

FIG. 5A schematically illustrates a video coding apparatus 500 according to Embodiment 1 of the present invention. Furthermore, FIG. 5B shows a flowchart of operations of the video coding apparatus 500. Although the following description shows an example of a video signal to be processed, other signals (for example, still images) may be provided, not limited to the video signal. As illustrated in FIG. 5A, the video coding apparatus 500 includes a coding unit 510, a decoding unit 520, a filter design unit 530, and a filter 540.

The coding unit 510 codes an input signal (also referred to as “a signal to be coded” and follows the same hereinafter). The input signals typically are signals composing a picture (frame). Here, “to be coded” means, for example, processing for quantizing the input signals. More specifically, the processing indicates generating a prediction error signal by subtracting a prediction signal from the input signals, DCT transforming the prediction error signal, quantizing the DCT-transformed prediction error signal, and generating quantized coefficients.

The decoding unit 520 decodes the signal coded by the coding unit 510. Here, “decodes” means, for example, processing for inverse quantizing the quantized coefficients. More specifically, the processing indicates inverse quantizing the quantized coefficients, generating a reconstructed signal through an inverse DCT transformation, and generating a decoded signal by adding the prediction signal to the reconstructed signal.

The filter design unit 530 calculates a filter coefficient based on an input signal and a decoded signal. More specifically, the filter design unit 530 includes an area forming unit 532, an estimation unit 534, and a coefficient calculation unit 536.

The area forming unit 532 subdivides the decoded signal into image areas. The specific example of the image areas are already described with reference to FIGS. 4A and 4B, and thus the descriptions are omitted herein. The specific example of a method of subdividing the area will be described later.

The estimation unit 534 estimates the first correlation data and the second correlation data. The first correlation data is a value indicating a correlation between an input signal and a decoded signal. The estimation unit 534 estimates the first correlation data for each area larger than one of the image areas determined by the area forming unit 532. In contrast, the second correlation data is a value indicating a spatial or temporal correlation between decoded signals. The estimation unit 534 estimates the second correlation data for each image area determined by the area forming unit 532. In other words, the estimation unit 534 estimates the first correlation data less frequently than the second correlation data.

The coefficient calculation unit 536 calculates a filter coefficient, using the first correlation data and the second correlation data. In other words, the coefficient calculation unit 536 calculates a filter coefficient for each image area determined by the area forming unit 532. The methods for obtaining the filter coefficient includes, for example, calculating a cross correlation vector and an autocorrelation matrix using the first correlation data and the second correlation data, and obtaining a product of the cross correlation vector and an inverse of the autocorrelation matrix as the filter coefficient.

The filter 540 filters a decoded signal using the filter coefficient calculated by the filter design unit 530. In other words, the filter 540 filters the decoded signal for each image area determined by the area forming unit 532. The specific examples of the filter 540 may include a deblocking filter, a loop filter, and an interpolation filter.

The signal coded by the coding unit 510 is provided to the video decoding apparatus 501. Similarly, the first correlation data out of the correlation data predicted by the estimation unit 534 is also provided to the video decoding apparatus 501. Although the output of the signal and the first correlation data may be separate, both of them may be entropy coded before the output. Here, “output” includes not only transmission to the video decoding apparatus 501 through a communication line and others but also transmission to a recording medium.

Next, the operations of the video coding apparatus 500 will be described with reference to FIG. 5B.

First, an input signal that is a video signal (also referred to as “a signal to be coded” and follows the same hereinafter) is provided to the coding unit 510 (S11). The coding unit 510 here may represent any single of the coding steps employed in hybrid video coding or their combination according to the domain in which the filtering is performed and/or the filter coefficients are estimated.

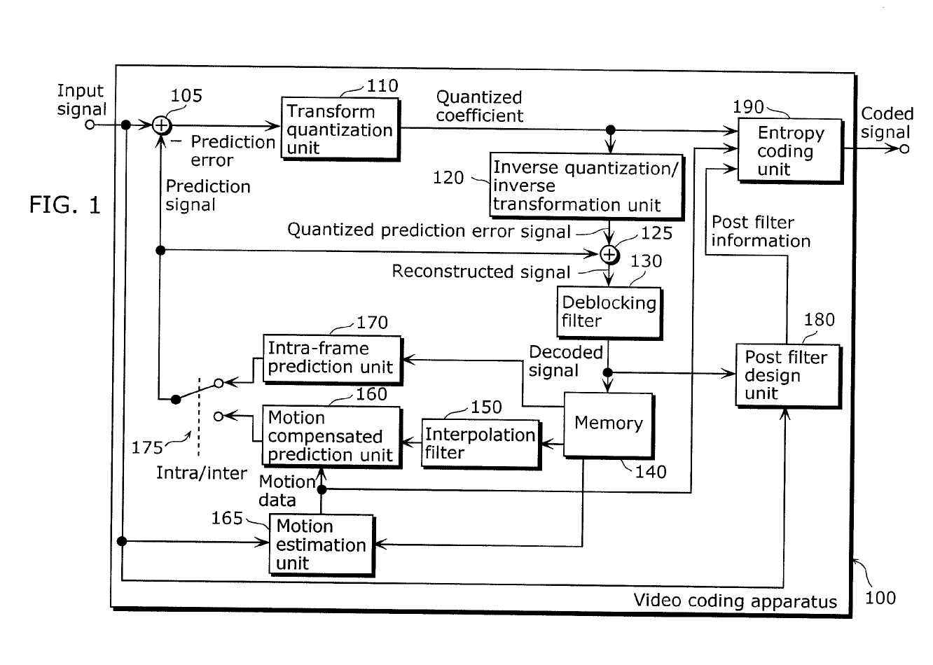

In other words, in the context of the present invention, the coding unit 510 performs any coding step that results in an irreversible change of the coded video signal with respect to the input video signal. Accordingly, the input signal in this context may be any data representing the video signal. For instance, when the coding unit 510 represents the transform quantization unit 110 in FIG. 1, the input signal corresponds to residuals (prediction error signal), i.e. to a difference between the original video signal and the prediction signal.

The coding unit 510 may also include a temporal prediction unit and/or a spatial prediction unit. In this case, the input signal corresponds to a video signal including image samples of video frames. Such input video signal may be in any format supported by the coding unit 510. Here, the format refers to a color space and a sampling resolution, the sampling resolution covering the arrangement and frequency of samples in space as well as the frame rate. The samples may include luminance values only for gray scale images, or a plurality of color components for color images.

The decoding unit 520 in the video coding apparatus 500 decodes video data coded by the coding unit 510 in order to obtain a decoded video signal (S12). The decoded video signal here refers to a video signal in the same domain as the input signal. The input signal corresponds to inverse-quantized and inverse-transformed residuals, or reconstructed video samples.

The input signal and the decoded signal are both input to the estimation unit 534 for estimating the correlation information necessary for calculating the filter coefficients. The estimation is performed for an image area, i.e., for a part of a video frame. The area forming unit 532 determines an image area. The filter design unit 530 according to an implementation of the present invention includes the three steps, namely, the area forming unit 532, the estimation unit 534, and the coefficient calculation unit 536. The calculated filter coefficients are then used to filter the determined image area using the filter 540.

A part of the estimated correlation information (the first correlation data) is provided to the video decoding apparatus 501. Preferably, the provided part of the correlation information is a part which cannot be determined by the video decoding apparatus 501, and a part relies on knowledge of a signal that is only available at the video coding apparatus 500. Here, the correlation data refers to any representation of second statistic moment related to the input signal and/or to the decoded signal, such as an autocorrelation, a cross correlation, auto covariance, and cross covariance. Depending on the format of the signal (an input signal or a decoded signal), this correlation data may have different form such as function, matrix, vector, and value. In general, the filter design unit 530, or any of its parts may perform processing in a domain different from the domain in which the filtering is performed.

The area forming unit 532 is an essential part of the filter design unit 530, and subdivides the decoded signal into image areas (S13). For the performance of filtering, the subdivision of an image into the groups of basic image elements is essential, since the elements belonging to one group should ideally have similar statistics. The size of groups determines the granularity of the local adaptation. In accordance with the present invention, the subdivision of the image into groups may be either fixed or adaptive. In the case of a fixed subdivision, the final granularity is achieved when each group is composed of a single image element.

However, calculating the optimum filter coefficients for each image element is a rather complex task especially if performed by the video decoding apparatus 501. Moreover, the side information to be signalized reduces the coding efficiency of the video coding. Therefore, for images with a plurality of image elements having similar statistical characteristics in particular, it can be beneficial to form the image element groups out of a plurality of image elements. Due to the changing content of natural video sequences, an adaptive subdivision is advantageous.

Here, the adaptive subdivision may either be signalized or derived in the same way by the video coding apparatus 500 and by the video decoding apparatus 501. Explicit subdivision which is coded and transmitted from the video coding apparatus 500 to the video decoding apparatus 501 has the advantage of full scalability, meaning that the image elements may be assigned to a particular image element group arbitrarily.

In general, the image area may be determined in an arbitrary manner as a subset of basic picture elements, which may be single values of a pixel, blocks, macroblocks, etc. Such a subset is not to necessarily continuous. The greatest flexibility of determining the image area is provided, when any subset of the image may be addressed. In order to inform the video decoding apparatus 501 of the image area selected by the video coding apparatus 500, the image area information thus has to be provided. Such image area information may contain, for example, a pattern specifying for each basic image element to which image area belongs. However, any other descriptions are possible, such as defining a shape and size of the area by a set of predefined parameters.

Another possibility is to subdivide an image by means of an object recognition algorithm such as clustering and to define image areas in accordance with the objects. The image area information then may be signalized, or the subdivision may be performed in the same way by the video decoding apparatus 501. It is an advantage that both the video coding apparatus 500 and the video decoding apparatus 501 determine an image area within a decoded image in the same way based on the same input information. The input information may be any information contained in the transmitted coded video signal and another video data associated therewith. Deriving the image area from the input data rather than from the additional side information reduces the signaling overhead and leads thus to higher coding efficiency. According to an implementation of the present invention, the performance of filtering does not necessarily suffer when the parameters for deriving the image areas are chosen in an appropriate way in order to identify image areas with possibly stationary characteristics.

For example, motion vectors may be used to subdivide the image into different moving parts corresponding to different objects in the image, since such objects probably have stationary or nearly stationary characteristics. Alternatively, the information about a prediction type, a quantization step size, or others can be used for subdivision. In particular in the video coding apparatus 500 already selecting coding parameters according to rate-distortion optimization, these parameters are reliable indication of the content characteristics of an image.

The subdivision of an image into image element groups may also be performed using parameters that can be derived by both the video coding apparatus 500 and the video decoding apparatus 501 and that are not necessarily transmitted from the video coding apparatus 500 to the video decoding apparatus 501. For instance, statistical characteristics of the image elements such as a local autocorrelation matrix may be used directly. Accordingly, the image elements may be subdivided into different groups based on the size of the local autocorrelation matrix at a certain position. Alternatively, any function of local autocorrelation matrix elements may be used to subdivide the image elements into groups. It may be beneficial also to combine a plurality of signalized video data parameters and/or parameters derived directly from a coded video signal.

The estimation unit 534 estimates the first correlation data and the second correlation data using the input signal and the decoded signal (S14). More specifically, the estimation 534 obtains, from the image area forming unit 532, the determined image area or information enabling determination of the image area. Additionally, it may use the input video signal as well as the decoded video signal for deriving statistic information controlling the design of the filter 540. According to an implementation of the present invention, the design of the filter is controlled by a local correlation function. For each image area, local correlation information (second correlation data) is determined based on the decoded (coded and decoded) video signal.

The same autocorrelation local correlation information may be derived by an estimation unit 564 in the video decoding apparatus 501, when the decoded image at both the video coding apparatus 500 and the video decoding apparatus 501 is the same, i.e. when the decoding unit 520 in the video coding apparatus 500 and the decoding unit 550 in the video decoding apparatus 501 work in the same way upon receipt of the same input signal (image area). Moreover, another correlation data (first correlation data) is derived by the estimation unit 564, based on the decoded video signal and on the input video signal. This information cannot be derived in the same way by the video decoding apparatus 501 since the video decoding apparatus 501 does not know the input video signal. Thus, according to an implementation of the present invention, this data is signalized from the video coding apparatus 500 to the video decoding apparatus 501.

The coefficient calculation unit 536 calculates a filter coefficient, using the first correlation data and the second correlation data that are estimated by the estimation unit 534 (S15). The filter 540 obtains the image area information determined by the area forming unit 534 and the filter coefficient calculated by the coefficient calculation unit 536, and filters the decoded signal for each image area. These operations lead to an improved subjective image quality of the decoded signals.

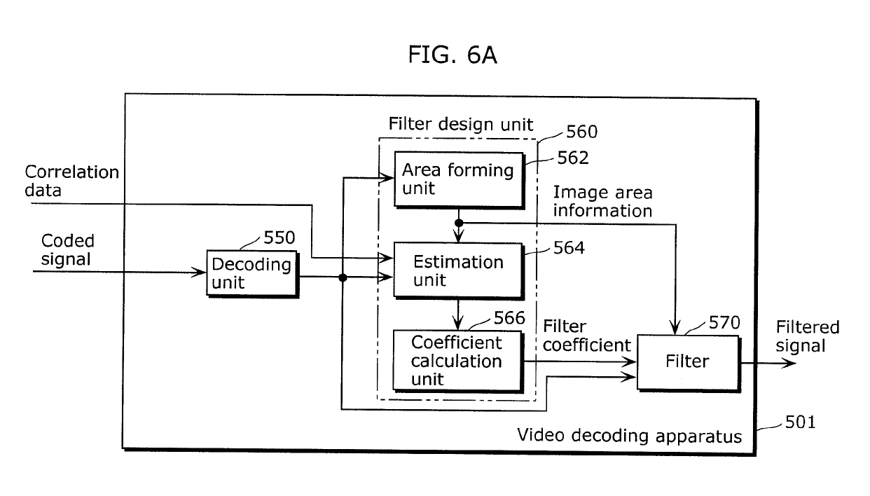

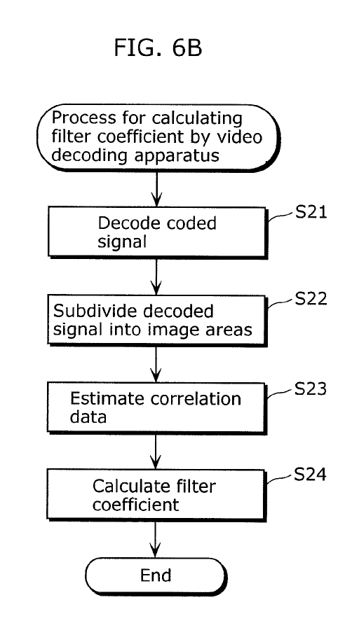

FIG. 6A schematically illustrates the video decoding apparatus 501 according to Embodiment 1 in the present invention. Furthermore, FIG. 6B shows a flowchart of operations of the video decoding apparatus 501. As illustrated in FIG. 6A, the video decoding apparatus 501 includes the decoding unit 550, a filter design unit 560, and a filter 570.

The decoding unit 550 decodes the coded signal obtained from the video coding apparatus 500. Here, “decodes” means, for example, processing for inverse quantizing quantized coefficients. More specifically, the processing includes inverse quantizing the quantized coefficients, generating a reconstructed signal through an inverse DCT transformation, and generating a decoded signal by adding a prediction signal to the reconstructed signal.

Alternatively, entropy decoding may be performed prior to the processing by the decoding unit 550. For example, suppose a case where the video coding apparatus 500 entropy decodes the quantized coefficients and the first correlation data to generate a coded signal. In this case, an entropy decoding unit (not illustrated) entropy decodes the coded signal to obtain the quantized coefficients and the first correlation data. Here, the quantized coefficients may be transformed into a decoded signal by the decoding unit 550, and the first correlation data may directly be provided to the filter design unit 560.

The filter design unit 560 calculates a filter coefficient using the first correlation data obtained from the video coding apparatus 500 and the decoded signal generated by the decoding unit 550. More specifically, the filter design unit 560 includes an area forming unit 562, the estimation unit 564, and a coefficient calculation unit 566.

The area forming unit 562 may subdivide the decoded signal into image areas in the same manner as the area forming unit 532 in FIG. 5A. Alternatively, the process may be omitted when the image area information is obtained from the video coding apparatus 500. The estimation unit 564 calculates the second correlation data in the same manner as the estimation unit 534 in FIG. 5A. The coefficient calculation unit 566 calculates a filter coefficient, using the first correlation data and the second correlation data as the coefficient calculation unit 536 in FIG. 5A.

The filter 570 filters the decoded signal using the filter coefficient calculated by the filter design unit 560. In other words, the filter 570 filters the decoded signal for each image area determined by the area forming unit 562. The specific examples of the filter 570 may include a deblocking filter, a loop filter, an interpolation filter, and a post filter.

Next, the operations of the video decoding apparatus 501 will be described with reference to FIG. 6B.

Upon receipt of the coded video signal, the decoding unit 550 decodes the coded video signal (S21). Next, the decoded video signal is transmitted to the filter design unit 560. The area forming unit 562 determines an image area corresponding to the decoded signal (S22). Additional image area information (not illustrated) may also be passed to the image area forming unit 562 in order to determine the image area. The first correlation data is obtained from the video coding apparatus 500. After the determination of the image area, the estimation unit 564 estimates local correlation data (second correlation data) (S23).

The first correlation data obtained by the video coding apparatus 500 and the second correlation data predicted by the estimation unit 564 are transmitted to the coefficient calculation unit 566 that calculates a filter coefficient to be used for filtering a determined image area. The coefficient calculation unit 566 calculates a filter coefficient for each image area based on the obtained first correlation data and second correlation data, and provides the calculated filter coefficient to the filter 570 (S24). The filter 570 obtains the image area information and the filter coefficient, and filters a decoded signal for each image area.

It is an advantage when the video coding apparatus 500 and the video decoding apparatus 501 match, i.e., when their functional blocks work in the same way and operate upon receipt of the same signals. For example, it is an advantage when the decoding unit 520 of the video coding apparatus 500 and the decoding unit 550 of the video decoding apparatus 501 are of the same configuration and/or when the image area forming unit 532, the estimation unit 534, and the coefficient calculation unit 536 of the video coding apparatus 500 match the image area forming unit 562, the estimation unit 564, and the coefficient calculation unit 566 of the video decoding apparatus 501, respectively. However, this does not necessarily have to be the case.

Moreover, the video decoding apparatus 501 according to Embodiment 1 in the present invention may be in general applied also to a video signal coded by a standard video coding apparatus such as an H.264/AVC based encoder, given that first correlation data is provided, which may be the case for the post filter design. Thus, the video coding apparatus 500 that codes data to be decoded by the video decoding apparatus 501 according to an implementation of the present invention, does not necessarily have to apply the filtering as applied by the video decoding apparatus 501.

The common correlation information (second correlation data) that can be derived by both the video coding apparatus 500 and the video decoding apparatus 501 is for example an autocorrelation function based on the decoded (coded and then decoded) image area. The correlation information (first correlation data) available only by the video coding apparatus 500 is for example based on a cross correlation between the input video signal and the decoded video signal. The first correlation data and the second correlation data are then used to derive the filter coefficients by the coefficient calculation units 536 and 566. In the following, a preferred embodiment of the present invention will be described, in which the filter coefficients are calculated as Wiener filter coefficients.

The input video signal of an image area is denoted as wherein the subscript L stands for “local”. The input video signal (also referred to as “original signal” and follows the same hereinafter) s_{L} is preferably a one-dimensional signal obtained by stacking the two-dimensional video signal in a vector. The image signal (also referred to as “decoded signal” and follows the same hereinafter) s_{L}′ obtained after coding using a lossy compression method can be expressed as a sum of the original image signal s_{L} and the noise n_{L} representing the degradation resulting from the coding/compression such as quantization noise. In order to reduce the amount of noise n_{L}, a Wiener filter is applied to the decoded signal s_{L}′, resulting in the filtered signal s_{L}″.

In order to obtain the filter coefficients of the Wiener filter, first, the autocorrelation matrix of the decoded signal s_{L}′ is determined. The autocorrelation matrix R_{L} of size M×M may be estimated by using realizations from the spatial and/or temporal neighborhood of the current image area. Furthermore, a local cross correlation vector p_{L} between the decoded (coded and then decoded) signal s_{L}′ to be filtered and the desired signal (original signal) s_{L} has to be estimated in order to calculate the coefficients of the locally adaptive Wiener filter. These coefficients are determined by solving the system of Wiener-Hopf equations, and the solution has the form as Equation 2.

w_{L}=R_{L}⁻¹ p_{L} [Equation 2]

Here, R_{L}⁻¹ denotes the inverse of the local autocorrelation matrix R_{L}. Parameter M is the order of the Wiener filter.

The autocorrelation matrix R_{L} can be determined by the video coding apparatus 500 and the video decoding apparatus 501 since it only uses the decoded signal s_{L}′ including the noise n_{L} for calculation. On the other hand, the local cross correlation vector p_{L} between the decoded signal (signal to be filtered) s_{L}′ and the original signal s_{L} can only be calculated by the video coding apparatus 500, since the knowledge of the original signal s_{L} is necessary.

According to Embodiment 1 in the present invention, after being derived by the video coding apparatus 500, the local cross correlation vector p_{L} is coded and provided together with the coded video data to the video decoding apparatus 501 for each image area for which the autocorrelation matrix R_{L} is determined. Embodiment 1 provides the highest adaptability to the image characteristics and consequently, the highest quality of the filtered image. However, the signaling overhead may reduce the coding efficiency even in cases where the local cross correlation vector p_{L} varies slowly and the overhead increases considerably as the size of an image area decreases.

Alternatively, K local cross correlation vectors p_{L,k}, (k=1 . . . , K) calculated for each frame (picture) are provided to the video decoding apparatus 501. The video decoding apparatus 501 selects one of the K local cross correlation vectors p_{L,k} for each image area, whereas the selection is derived, for instance, from the local autocorrelation matrix R_{L} which is estimated for each image area separately. For this purpose, again, a value of a particular element of the local autocorrelation matrix R_{L} or any function of its element(s) may be used. For instance, each of the K local cross correlation vectors p_{L,k} may be associated with each interval of values of a predetermined element of the autocorrelation matrix R_{L}. However, the one of the K local cross correlation vectors p_{L,k} may also be selected based on information signalized as a part of the video data (for instance, a prediction type, motion information, a quantization step size, etc. similarly to the parameters for determining the image area). The selected one of the K local cross correlation vectors p_{L,k} may also be signalized explicitly.

According to another embodiment in the present invention, only one global cross correlation vector p may be provided to the video decoding apparatus 501 for each frame (picture). For each image area, the Wiener filter may be determined by using the thus transmitted global cross correlation vector p and the locally estimated autocorrelation matrix R_{L}. The Wiener filter coefficients are then given by Equation 3.

w_{L}=R_{L}⁻¹ p [Equation 3]

Providing the global cross correlation vector only reduces the amount of side information to be sent. At the same time, certain local adaptability is achieved by calculating the autocorrelation matrix locally.

In accordance with a preferred embodiment in the present invention, however, each local cross correlation vector p_{L} is separated into two parts as shown in Equation 4.

p_{L}=p_{L,s′}+pₙ [Equation 4]

Here, the first part p_{L,S′} depends only on the statistic of the decoded signal s_{L}′ to be filtered, and the second part pₙ depends only on the statistic of the added noise signal n. Such subdivision of the local cross correlation vector p_{L} is possible under the following assumptions.

First, the correlation between the noise signal n_{L} and the input signal s_{L} is zero as shown in the following Equations 5 and 6.

E[s_{L}(x)·n_{L}(x)]=0 [Equation 5]

E[s_{L}(x−1)·n_{L}(x)]=0 [Equation 6]

Next, the statistic of the added noise is independent of the local image area as shown in the following Equations 7 and 8.

E└n_{L}²(x)┘=E└n²(x)┘ [Equation 7]

E[n_{L}(x)·n_{L}(x−1)]=E[n(x)·n(x−1)] [Equation 8]

Here, s_{L}(x) denotes an element of the stochastic local input signal vector s_{L}=[s_{L}(x), s_{L}(x−1), . . . , s_{L}(x−M+1)]. s_{L}′(x) denotes an element of the stochastic local noise signal vector s_{L}′=[s_{L}′(x), s_{L}′(x−1), . . . , s_{L}′(x−M+1)]. n(x) denotes an element of the stochastic noise vector n=[n(x), n(x−1), . . . , n(x−M+1)]. n_{L}(x) denotes an element of the stochastic local noise vector n_{L}=[n_{L}(x), n_{L}(x−1), . . . , n_{L}(x−M+1)]. Operator E denotes expectation.

The local filter coefficients w_{1,L} and w_{2,L} of the Wiener filter with order M=2 are calculated using the Wiener-Hopf equation as shown in Equation 9.

$$[ \begin{matrix}E [ {s}_{L} ( x ) {s}_{L}^{′} ( x ) ] \\ E [ {s}_{L} ( x ) {s}_{L}^{′} ( x - 1 ) ]\end{matrix} ] = [ \begin{matrix}E [ {s}_{L}^{′} ( x ) {s}_{L}^{′} ( x ) ] & E [ {s}_{L}^{′} ( x ) {s}_{L}^{′} ( x - 1 ) ] \\ E [ {s}_{L}^{′} ( x ) {s}_{L}^{′} ( x - 1 ) ] & E [ {s}_{L}^{′} ( x - 1 ) {s}_{L}^{′} ( x - 1 ) ]\end{matrix} ] [ \begin{matrix}{w}_{1 , L} \\ {w}_{2 , L}\end{matrix} ] \qquad [ Equation 9 ]$$

After substituting the equation s_{L}(x)=s_{L}′(x)−n_{L}(x), the first element of the local cross correlation vector p_{L} can be expressed as the following Equation 10.

E[s_{L}(x)s′_{L}(x)]=E[s′_{L}(x)s′_{L}(x)]−E└n_{L}²(x)┘−E[s_{L}(x)n_{L}(x)] [Equation 10]

Similarly, the second element of the local cross correlation vector p_{L} is given by the following Equation 11.

E[s_{L}(x)·s′_{L}(x−1)]=E[s′_{L}(x)·s′_{L}(x−1)]−E[n_{L}(x)·n_{L}(x−1)]−E[s_{L}(x−1)·n_{L}(x)] [Equation 11]

Considering the above-mentioned assumptions, the local cross correlation vector p_{L} can finally be expressed as the following Equation 12.

$${p}_{L} = \underbrace{[ \begin{matrix}E [ {s}_{L}^{′} ( x ) \cdot {s}_{L}^{′} ( x ) ] \\ E [ {s}_{L}^{′} ( x ) \cdot {s}_{L}^{′} ( x - 1 ) ]\end{matrix} ]}_{{p}_{L , {s}^{′}}} + \underbrace{[ \begin{matrix}- E [ {n}^{2} ( x ) ] \\ - E [ n ( x ) \cdot n ( x - 1 ) ]\end{matrix} ]}_{{p}_{n}} \qquad [ Equation 12 ]$$

The first part p_{L,s′} depends only on the local corrupted decoded signal s_{L}′ and can thus be determined by both the video coding apparatus 500 and the video decoding apparatus 501. The second part p_{L,n} depends only on the added noise signal. The second part is not known by the video coding apparatus 501 but only by the video coding apparatus 500. Thus, the second part has to be provided together with the coded data to the video decoding apparatus 501.

Since it is assumed that the statistics of the added noise is independent of the local image area, this information does not necessarily have to be provided for each image area. Preferably, the part of the cross correlation vector p_{L} is preferably provided only once per frame (picture). By the use of the provided statistics of the added noise and the measured local autocorrelation matrix R_{L} as well as the corresponding part of cross correlation vector p_{L} related to the decoded signal only, as described above, the video coding apparatus 500 and the video decoding apparatus 501 can determine the optimal coefficients of the Wiener filter for each image area. Using these optimal coefficients, each image area can be filtered.

For the cases when the second condition, namely the statistics of the added noise being independent of the local image area, is not applied, it may be an advantage to estimate and signalize the noise autocorrelation more frequently. Then, each local cross correlation vector p_{L} is separated into two parts as shown in the following Equation 13.

p_{L}=p_{L,s′}+p_{L,n} [Equation 13]

Here, the autocorrelation of noise p_{L,n} is local. The assumption of zero correlation between noise and an input signal, as well, is not always fulfilled, especially in the case of an image signal with low variance and of coarse quantization (corresponding to high quantization parameter values), since quantization reduces the variance of the image signal. Consequently, the noise signal may represent the parts of the image signal itself and thus may be highly correlated therewith. Nevertheless, the zero correlation assumption becomes true for an image signal with high variance and of fine quantization, which is associated with a high signal-to-noise ratio. A further improvement in the calculation of local Wiener filter coefficients is achieved when the zero correlation between noise and input signals is not assumed, i.e. the values of the two terms E[s_{L}(x)·n_{L}(x)] and E[s_{L}(x−1)·n_{L}(x)] are also estimated.

The estimated values may be provided to the video decoding apparatus 501. However, preferably, the two terms are estimated locally by the video coding apparatus 500 and the video decoding apparatus 501 without exchanging extra side information. The estimation can be performed, for instance, based on the statistics of the decoded signal to be filtered such as variance, and by the transmitted quantization information such as the quantization parameter in combination with the quantization weighting matrices. For this estimation, further parameters may also be transmitted from the video coding apparatus 500 to the video decoding apparatus 501. Such parameters may define, for example, a function for the two terms dependent on the variance of the decoded signal to be filtered. The function may be, but does not need to be, a linear function.

In accordance with another embodiment of the present invention, the autocorrelation function of the noise pₙ (either local or global) is estimated by using the known quantization step sizes which are defined by the quantization parameter in combination with weighting matrices. For the case of one dimensional signal s′_{L}(x) and M=2, the local filter coefficients leading to the local minimum mean squared error can be determined with a known pₙ by the following Equation 14.

$$[ \begin{matrix}{w}_{1 , L} \\ {w}_{2 , L}\end{matrix} ] = {[ \begin{matrix}E [ {s}_{L}^{′} ( x ) {s}_{L}^{′} ( x ) ] & E [ {s}_{L}^{′} ( x ) {s}_{L}^{′} ( x - 1 ) ] \\ E [ {s}_{L}^{′} ( x ) {s}_{L}^{′} ( x - 1 ) ] & E [ {s}_{L}^{′} ( x - 1 ) {s}_{L}^{′} ( x - 1 ) ]\end{matrix} ]}^{- 1} ( [ \begin{matrix}E [ {s}_{L}^{′} ( x ) {s}_{L}^{′} ( x ) ] \\ E [ {s}_{L}^{′} ( x ) {s}_{L}^{′} ( x - 1 ) ]\end{matrix} ] + {p}_{n} ) \qquad [ Equation 14 ]$$

Accordingly, the local filter coefficients may be calculated by the video coding apparatus 500 and the video decoding apparatus 501 without exchanging side information. When the side information is not provided, the method can be beneficially used, instead of calculating the filter coefficients based on the provided side information.

Accordingly, the local filter coefficients may be calculated by the video coding apparatus 500 and the video decoding apparatus 501 without exchanging the side information. When side information is not provided, the method can be beneficially used instead of calculating the filter coefficients based on the provided side information.

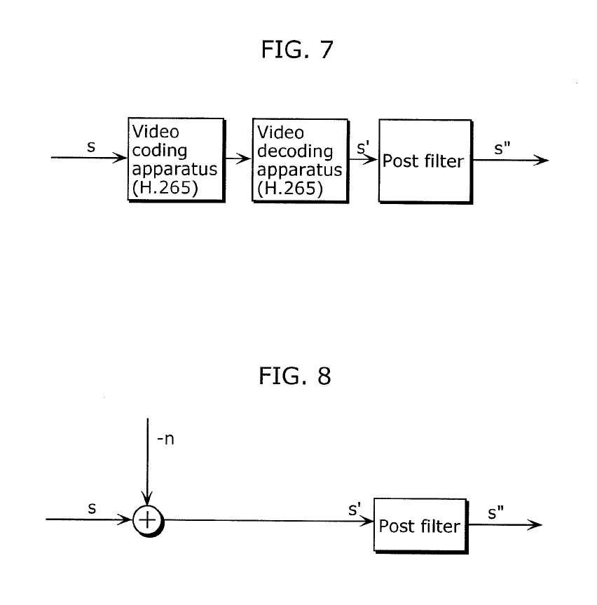

According to another embodiment of the present invention, a coding system using a Wiener post filter for noise reduction is used as illustrated in a block diagram of FIG. 7. According to the following conventional techniques, the post filter is a linear Wiener filter that conforms to the following Equation 15.

T. Wiegand, G. Sullivan, J. Reichel, H. Schwarz, M. Wien, “Joint draft ITU-T Rec. H.264|ISO/IEC 14496-10/Amd.3 Scalable video coding” (NPL 3), JVT-X201, ISO/IEC MPEG&ITU-T VCEG, Joint Video Team, Geneva, Switzerland, Jun. 29 to Jul. 5, 2007.

S. Wittmann, T. Wedi, “SEI message on post-filter hints” (NPL 4), Joint Video Team (JVT), Hangzhou, China, October 2006.

S. Wittmann, T. Wedi, Proceedings, “Transmission of Post-Filter Hints for Video Coding Schemes” (NPL 5), IEEE International Conference on Image Processing (ICIP 2007), San Antonio, Tex., USA, September, 2007.

$${s}^{″} ( x ) = {\sum }_{k = 1}^{K} {a}_{k} \cdot {s}^{′} ( {x}_{k} ) \qquad [ Equation 15 ]$$

Here, s″(x) denotes a filtered signal in a position x. K filter coefficients are represented as a₁, . . . , a_{K}. s′(xₖ) denotes a signal to be filtered in a position xₖ of the K filter coefficients, and is used in a filtering process. The minimum mean squared error between s and s″ (E[(s″−s)2]→min) derives the following known Equations 16, 17, and 18.

$$\begin{matrix}{R}_{{s}^{′} {s}^{′}} \cdot \vec{a} = \vec{k} & [ Equation 16 ] \\ {R}_{{s}^{′} {s}^{′}} = [ \begin{matrix}E [ {s}^{′} ( {x}_{1} ) \cdot {s}^{′} ( {x}_{1} ) ] & E [ {s}^{′} ( {x}_{2} ) \cdot {s}^{′} ( {x}_{1} ) ] & … & E [ {s}^{′} ( {x}_{K} ) \cdot {s}^{′} ( {x}_{1} ) ] \\ E [ {s}^{′} ( {x}_{1} ) \cdot {s}^{′} ( {x}_{2} ) ] & ⋱ & ⋱ & ⋮ \\ ⋮ & ⋱ & ⋱ & ⋮ \\ E [ {s}^{′} ( {x}_{1} ) \cdot {s}^{′} ( {x}_{K} ) ] & … & … & E [ {s}^{′} ( {x}_{K} ) \cdot {s}^{′} ( {x}_{K} ) ]\end{matrix} ] & [ Equation 17 ] \\ \vec{a} = [ \begin{matrix}{a}_{1} \\ ⋮ \\ ⋮ \\ {a}_{K}\end{matrix} ] and \vec{k} = [ \begin{matrix}E [ s ( x ) \cdot {s}^{′} ( {x}_{1} ) ] \\ ⋮ \\ ⋮ \\ E [ s ( x ) \cdot {s}^{′} ( {x}_{K} ) ]\end{matrix} ] & [ Equation 18 ]\end{matrix}$$

Here, R_{s′s′} denotes an autocorrelation matrix of the signal x′, and can be calculated by both the video coding apparatus 500 and the video decoding apparatus 501. The vector a→ includes the K filter coefficients a₁, . . . , a_{K}. Here, a symbol “→ (vector)” shows a symbol to be attached on a character immediate before the current character, and is used in such a meaning hereinafter in the Description. The vector k→ includes a cross correlation value between the original signal s and the decoded signal s′. Since the cross correlation vector k→ is known not by the video decoding apparatus 501 but only by the video coding apparatus 500, it needs to be transmitted to the video decoding apparatus 501.

The original signal s can be represented by the following Equation 19 as a result of addition of the decoded signal s′ and the noise n that has been added in the quantization process of the video coding apparatus 500.

s=s′+n [Equation 19]

Thus, the decoded signal s′ that is an output of a video coding apparatus and a video decoding apparatus in FIG. 7 can be represented by subtracting the noise signal n from the original signal s. The coding system in FIG. 7 is changed to the one shown in FIG. 8. When s=s′+n, the cross correlation vector k→ can be represented by the following Equation 20.

$$\begin{matrix}\vec{k} = [ \begin{matrix}E [ s ( x ) \cdot {s}^{′} ( {x}_{1} ) ] \\ ⋮ \\ ⋮ \\ E [ s ( x ) \cdot {s}^{′} ( {x}_{K} ) ]\end{matrix} ] \\ = \underbrace{[ \begin{matrix}E [ {s}^{′} ( x ) \cdot {s}^{′} ( {x}_{1} ) ] \\ ⋮ \\ ⋮ \\ E [ {s}^{′} ( x ) \cdot {s}^{′} ( {x}_{K} ) ]\end{matrix} ]}_{{\to }_{r}} + \\ \underbrace{[ \begin{matrix}E [ n ( x ) \cdot {s}^{′} ( {x}_{1} ) ] \\ ⋮ \\ ⋮ \\ E [ n ( x ) \cdot {s}^{′} ( {x}_{K} ) ]\end{matrix} ]}_{{\to }_{g}}\end{matrix} \qquad [ Equation 20 ]$$

As apparent from Equation 20, the cross correlation vector k→ can be divided into 2 parts, r→ and g→. r→ can be calculated by both the video coding apparatus 500 and the video decoding apparatus 501. Thus, only g→ can be transmitted instead of k→. Thus, the optimal filter coefficient a→ can be derived from the following Equation 21.

R_{s′s′}·\vec{a}=\vec{r}+\vec{g} [Equation 21]

Multiplication of each element by the inverse of the local autocorrelation matrix R_{s′s′} results in the following Equation 22.

\vec{a}=R_{s′s′}⁻¹·\vec{r}+R_{s′s′}⁻¹·\vec{g} [Equation 22]

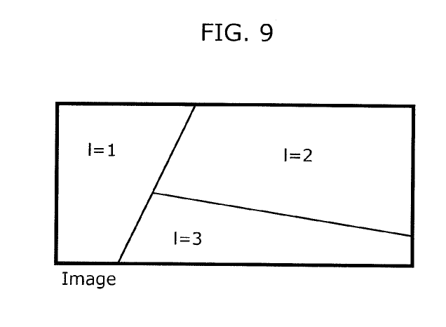

Suppose an image is subdivided into L local areas (image areas) l=1, . . . , L. FIG. 9 illustrates an example when L=3. A probability Pₗ that is an index between the number of samples in an area l and the number of samples in a whole image is associated with each local area as shown in the following Equation 23.

$${P}_{l} = \frac{\# Samples in area l}{\# Samples in whole image} \qquad [ Equation 23 ]$$

The optimal filter coefficient for each local area can be calculated using the following Equation 24.

\vec{a}ₗ=R_{s′s′,l}⁻¹·\vec{r}ₗ+R_{s′s′,l}⁻¹·\vec{g}ₗ [Equation 24]

Here, the subscript l denotes the area. Furthermore, the local adaptive filtering obtains 2 solutions as follows.

First, an individual filter coefficient that is independent in each area l is coded and transmitted. The process can be implemented by coding one of a→ₗ and g→ₗ, and transmitting the coded one of a→ₗ and g→ₗ. Compared to the global adaptive filtering, the data amount to be coded and transmitted is multiplied by a coefficient L.

Second, assume g→ₗ₌g→(A⁻¹)|=1, . . . , L. Here, (A⁻¹) denotes a universal quantifier (∀). In this case, only g→ is coded, and transmitted from the video coding apparatus 500 to the video decoding apparatus 501. Compared to the global adaptive filtering, the amount of data to be coded and transmitted is the same. The locally adaptive filter coefficient is calculated by the video coding apparatus 500 and the video decoding apparatus 501 using Equation 24. Compared to the global adaptive filtering, the advantage of the locally adaptive filtering is that knowledge of the local autocorrelation matrix R_{s′s′,l} can be used in each local area.

How the video coding apparatus 500 can estimate the best-match vector g→ of the solution will be described next. The best-match vector g→ is for minimizing the mean squared error between the original signal s and the signal s″ that is locally adaptively filtered. The minimum mean squared error (E[(s″−s)2]→min) is derived as the following Equation 25 when a signal is locally adaptively filtered.

E[(s−s″)²]=E└(s₁−\vec{a}₁^{T}·\vec{s}₁′)²┘·P₁+ . . . +E└(s_{L}−\vec{a}_{L}^{T}·\vec{s}_{L}′)²┘·P_{L}→min [Equation 25]

The shortcuts are used as shown in the following Equation 26.

$${\vec{a}}_{l} = \underbrace{{R}_{{s}^{′} {s}^{′} , l}^{- 1} \cdot \vec{r}}_{{\vec{v}}_{l}} + \underbrace{{R}_{{s}^{′} {s}^{′} , l}^{- 1}}_{{M}_{l}} \cdot \vec{g} ⇒ {\vec{a}}_{l} = {\vec{v}}_{l} + {M}_{l} \cdot \vec{g} \qquad [ Equation 26 ]$$

The mean squared error is expressed as the following Equations 27, 28, 29, and 30 using these shortcuts.

$$\begin{matrix}E [ {( s - {s}^{″} )}^{2} ] = {\sum }_{l = 1}^{L} {P}_{ l} \cdot E [ {( \begin{matrix}\underbrace{{s}_{l} - {\vec{v}}_{l}^{T} \cdot {\vec{s}}_{l}^{′}}_{{q}_{l}} - \\ {( {M}_{l} \cdot \vec{g} )}^{T} \cdot {\vec{s}}_{l}^{′}\end{matrix} )}^{2} ] min & [ Equation 27 ] \\ E [ {( s - {s}^{″} )}^{2} ] = {\sum }_{l = 1}^{L} {P}_{l} \cdot E [ {( \begin{matrix}\underbrace{{s}_{l} - {\vec{v}}_{l}^{T} \cdot {\vec{s}}_{l}^{′}}_{{q}_{l}} - \\ \underbrace{{( {M}_{l} \cdot {s}_{l}^{′} )}^{T}}_{{b}_{l}^{T}} \cdot \vec{g}\end{matrix} )}^{2} ] min & [ Equation 28 ] \\ ⇒ E [ {( s - {s}^{″} )}^{2} ] = {{\sum }_{l = 1}}^{L} {P}_{l} \cdot E [ {( {q}_{l} - {\vec{b}}_{l}^{T} \cdot \vec{g} )}^{2} ] min & [ Equation 29 ] \\ ⇒ E [ {( s - {s}^{″} )}^{2} ] = {\sum }_{l = 1}^{L} {P}_{l} \cdot E [ {( \begin{matrix}{q}_{l} - \\ {\sum }_{k = 1}^{K} {b}_{l , k} \cdot {g}_{k}\end{matrix} )}^{2} ] min & [ Equation 30 ]\end{matrix}$$

In order to calculate the best-match vector g→, K-number E[(s−s″)2] are calculated as shown in the following Equations 31 and 32, and are set to 0.

$$\begin{matrix}\begin{matrix}\frac{d E [ {( s - {s}^{″} )}^{2} ]}{d {g}_{i}} = {\sum }_{l = 1}^{L} {P}_{l} \cdot E [ - 2 \cdot ( {q}_{l} - {\sum }_{k = 1}^{K} {b}_{l , k} \cdot {g}_{k} ) \cdot {b}_{l , i} ] \\ = 0 ∀ i = 1 , … , K\end{matrix} & [ Equation 31 ] \\ ⇒ {\sum }_{l = 1}^{L} {P}_{l} \cdot E [ {q}_{l} \cdot {b}_{l , i} ] = {\sum }_{l = 1}^{L} {P}_{l} \cdot E [ {\sum }_{k = 1}^{K} {b}_{l , k} \cdot {g}_{k} \cdot {b}_{l , i} ] \\ ∀ i = 1 , … , K & [ Equation 32 ]\end{matrix}$$

Equation 33 is derived from Equation 32.

$$[ \begin{matrix}{\sum }_{l = 1}^{L} {P}_{l} \cdot E [ {q}_{l} \cdot {b}_{l , 1} ] \\ ⋮ \\ ⋮ \\ {\sum }_{l = 1}^{L} {P}_{l} \cdot E [ {q}_{l} \cdot {b}_{l , K} ]\end{matrix} ] = [ \begin{matrix}{\sum }_{l = 1}^{L} {P}_{l} \cdot E [ {b}_{l , 1} \cdot {b}_{l , 1} ] & {\sum }_{l = 1}^{L} {P}_{l} \cdot E [ {b}_{l , 1} \cdot {b}_{l , 2} ] & … & {\sum }_{l = 1}^{L} {P}_{l} \cdot E [ {b}_{l , 1} \cdot {b}_{l , K} ] \\ {\sum }_{l = 1}^{L} {P}_{l} \cdot E [ {b}_{l , 2} \cdot {b}_{l , 1} ] & ⋱ & ⋱ & ⋮ \\ ⋮ & ⋱ & ⋱ & ⋮ \\ {\sum }_{l = 1}^{L} {P}_{l} \cdot E [ {b}_{l , K} \cdot {b}_{l , 1} ] & … & … & {\sum }_{l = 1}^{L} {P}_{l } \cdot E [ {b}_{l , 1} \cdot {b}_{l , 1} ]\end{matrix} ] \cdot [ \begin{matrix}{g}_{1} \\ ⋮ \\ ⋮ \\ {g}_{K}\end{matrix} ] \qquad [ Equation 33 ]$$

Thus, the best-match vector g→ can be calculated from Equation 33 as the following Equation 34.

$$[ \begin{matrix}{g}_{1} \\ ⋮ \\ ⋮ \\ {g}_{K}\end{matrix} ] = {[ \begin{matrix}{\sum }_{l = 1}^{L} {P}_{l} \cdot E [ {b}_{l , 1} \cdot {b}_{l , 1} ] & {\sum }_{l = 1}^{L} {P}_{l} \cdot E [ {b}_{l , 1} \cdot {b}_{l , 2} ] & … & {\sum }_{l = 1}^{L} {P}_{l} \cdot E [ {b}_{l , 1} \cdot {b}_{l , K} ] \\ {\sum }_{l = 1}^{L} {P}_{l} \cdot E [ {b}_{l , 2} \cdot {b}_{l , 1} ] & ⋱ & ⋱ & ⋮ \\ ⋮ & ⋱ & ⋱ & ⋮ \\ {\sum }_{l = 1}^{L} {P}_{l} \cdot E [ {b}_{l , K} \cdot {b}_{l , 1} ] & … & … & {\sum }_{l = 1}^{L} {P}_{l} \cdot E [ {b}_{l , 1} \cdot {b}_{l , 1} ]\end{matrix} ]}^{- 1} \cdot [ \begin{matrix}{\sum }_{l = 1}^{L} {P}_{l} \cdot E [ {q}_{l} \cdot {b}_{l , 1} ] \\ ⋮ \\ ⋮ \\ {\sum }_{l = 1}^{L} {P}_{l} \cdot E [ {q}_{l} \cdot {b}_{l , K} ]\end{matrix} ] \qquad [ Equation 34 ]$$

The video decoding apparatus 501 needs to perform the following decoding. First, a coded best-match vector g→ is decoded. Next, the decoded image is subdivided into L local areas, for example, according to a technique to be described in a section later. Next, L autocorrelation functions R_{s′s′,l}, . . . , R_{s′s′,L} are calculated. Next, using Equation 24, the optimal filter coefficient a→ₗ for each local area with an index l=1, . . . ,L can be calculated. Then, the local area with the index l=1, . . . ,L is filtered using the optimal filter coefficient a→ₗ.

In another embodiment of the present invention, the image signal is subdivided into L local areas according to the local autocorrelation function R_{s′s′,L}. In the subdivision, only information that is available by both the video coding apparatus 500 and the video decoding apparatus 501 is used. In this case, the video decoding apparatus 501 can perform the same subdivision performed by the video coding apparatus 500 without any additional side information.

In order to use the local autocorrelation function R_{s′s′,L} as it is when a filter coefficient is calculated, the local autocorrelation function R_{s′s′,L} is preferably used in the subdivision. For example, an image can be subdivided into smaller areas having a larger number (L_{large}>>L) using l_{large}=1, . . . L_{large}. The autocorrelation function R_{s′s′,llarge} (“large” is a subscript of “l” and follows the same hereinafter) is calculated for the smaller areas to each of which the index L_{large} is attached. Each element of the autocorrelation function R_{s′s′,llarge} is assumed to be a vector. Here, a code book for a vector quantizer has been designed in accordance with the LBG or Lloyd algorithm. In the design of the code book, L representative vectors are derived using vectors derived from the R_{s′s′,llarge}=1, . . . , R_{s′s′,Llarge} as a species.

Next, each local area to which the index L_{large} is attached is associated with a local area to which the index l is attached, by, for example, minimizing a result of the calculation of the mean squared error between vector elements, in other words, between the elements of the autocorrelation functions R_{s′s′,l}.

The subdivision method largely makes the autocorrelation functions R_{s′s′,l} in local areas different from each other. The largely different autocorrelation functions R_{s′s′,l} derive filter coefficients that are largely different from each other. Thus, the coding efficiency will be improved maximally.

The decoded signal s′ is subdivided into L local areas according to a local prediction type, a local motion vector, and/or a quantization step size, in another embodiment of the present invention. Since such information is known by both the video coding apparatus 500 and the video decoding apparatus 501, the information can be used without increase in the bit rate.

The local motion vector is used as described below. The decoded signal s′ is, in general, subdivided into blocks, and a motion vector is allocated to each of the blocks. For example, a first local area may be composed of blocks each having a motion vector that is smaller than a first threshold. Furthermore, a second local area may be composed of blocks each having a motion vector that is not smaller than the first threshold but smaller than a second threshold (>the first threshold). Furthermore, a third local area may be composed of blocks each having a motion vector that is larger than the second threshold.

This shows the classification according to a size of a motion vector. The size of a motion vector can be derived by calculation of an absolute value of a motion. The classification is preferably performed by calculation of a threshold. For example, the video coding apparatus 500 may determine the threshold by obtaining a Lagrangian cost of a bit rate and minimizing the mean squared reconstruction error.

Then, the coded threshold may be transmitted to the video decoding apparatus 501. As another example, motion vectors are classified according to each direction. The direction of each of the motion vectors can be represented by an angle. The angle can be calculated from spatial components of each of the motion vectors using inverse tangent. These vectors can be classified according to each angle using a threshold. For example, the video coding apparatus 500 may determine the threshold by obtaining a Lagrangian cost of a bit rate and minimizing the mean squared reconstruction error. Then, the coded threshold may be transmitted to the video decoding apparatus 501. The advantage of forming a local area according to each motion vector is that statistical characteristics of a local image are similar between blocks having similar motion vectors.

The local prediction type is used as described below. All of the blocks of the image signals are classified according to each local prediction type. This means that a first local image area is composed of all of blocks having a prediction type, and a second local image area is composed of all of blocks having another prediction type, for example. The advantage of forming a local area according to a prediction type is that statistical characteristics of a local image are similar between blocks that are of the same prediction type. The prediction types may be classified into 2 types of intra prediction (I picture) and inter prediction, and may be classified into 3 types (I picture, P picture, and B picture) by further classifying the inter prediction into the P picture and B picture.

The local quantization step size is used as described below. All of the blocks of the image signals are classified according to each local quantization step size. The local quantization step size for each local area is transmitted from the video coding apparatus 500 to the video decoding apparatus 501. The local quantization step size is added to the original signal to affect the quantization noise that appears in a decoded signal. Since the statistical characteristics of the decoded signal and the optimal Wiener filter coefficients are determined according to the added quantization noise, using the local quantization step size is very advantageous for the classification. This means that a first local image area is composed of all of blocks having a first quantization step size, and a second local image area is composed of all of blocks having a second quantization step size that is different from the first quantization step size, for example.

The video coding apparatus 500 and the video decoding apparatus 501 according to a preferred embodiment of the present invention is based on the H.264/AVC standard. In other words, the video coding apparatus 500 and the video decoding apparatus 501 are based on the hybrid video coding as described in Background Art of the Description. The video coding apparatus 500 and the video decoding apparatus 501 may be in accordance with, for example, a standardized enhancement of the present H.264/AVC standard, any future video coding standard, or any proprietary version based on the principles of H.264/AVC coding and decoding.

H.264/AVC employs two different inverse transforms for application to blocks of different sizes: 4×4 and 8×8 inverse transforms. Since the inverse transforms define the autocorrelation function of the noise, it may also be an advantage to estimate and possibly also to provide individual autocorrelation vectors of the noise signal (or the cross-terms of the cross correlation vector, or the whole cross correlation vector). One such individual autocorrelation vector is then used for the picture elements that are processed with the 4×4 transform, and the other one is used for the picture elements that are processed with the 8×8 transform.

It may also be an advantage to provide and/or estimate individual autocorrelation vectors of the noise signal for Intra-coded and Inter-coded picture elements, which may be blocks, macroblocks or groups of either. The determination of an image area may also take into account the type of picture elements and a rule may be applied that an image area contains only picture element of the same type (Inter/Intra, I/P/B). A further refinement can be achieved by providing and/or estimating individual autocorrelation vectors of the noise signal for the various block sizes that are used in the Intra prediction and in the Inter prediction.

Another advantageous example is providing and/or estimating individual autocorrelation vectors of a noise signal for picture elements that are associated with large quantized prediction errors and small quantized prediction errors. For instance, there may be a plurality of intervals of (mean) values of the quantized prediction errors, and an individual correlation vector of the noise signal may be provided for each of the intervals.

Yet another advantageous example is providing and/or estimating individual autocorrelation vectors of a noise signal depending on the associated motion vector(s) and the surrounding motion vectors. A large difference of the associated motion vector with the surrounding ones is an indicator for a local object. At local objects, generally a large prediction error occurs, resulting in a large quantization error if the quantization is coarse.

It should be noted that the information to be provided as described in all above examples does not need to be the autocorrelation vector of noise. It may be the entire cross correlation vector, or its arbitrary part(s) of the cross correlation vector. In addition, the number of provided elements may be signalized together with the elements of the correlation data.

Providing side information (cross correlation vector or its part) for calculating filter coefficients by the video coding apparatus 500 for the video decoding apparatus 501 is not limited to the examples described above. The frequency of providing the side information does not need to be regular. Moreover, the frequency of estimating and providing the side information does not need to be the same.

According to yet another embodiment in the present invention, the side information is estimated for each image area. The video coding apparatus 500 further includes a rate-distortion optimization unit capable of deciding whether or not sending the side information would improve the quality of filtered image considering the rate necessary for transmitting/storing thereof.

The rate-distortion optimization unit may further decide which parts of the cross correlation vector shall be provided, i.e. whether sending of parts containing cross-terms is necessary or whether sending of a part related to a noise autocorrelation would be sufficient. This decision may be made by comparing the results of filtering using coefficients calculated based on a cross correlation vector estimated in various manners, or based on a rate-distortion optimization (for example, the cross correlation vector may be the part related to noise only, cross-terms, a cross correlation vector common for the whole image, a cross correlation vector out of a predefined set of cross correlation vectors). The rate-distortion optimization unit may be a part of a rate-distortion optimization unit of the video coding apparatus 500 and may in addition perform optimization of various other coding parameters, such as a prediction type and a quantization step size, apart from filtering.

Alternatively, the decision on whether or not to send the side information may be made based on the statistics of noise or on the statistics of noise with respect to the signal. For instance, a value of an element of the cross correlation vector or its part may be compared to a threshold and based upon the comparison, the decision may be made. Preferably, the decision is made based on the change of the statistics between different image areas.

Sending the first correlation data less frequently than estimating the local correlation data based on the decoded video signal only allows for improving the coding efficiency in comparison with the case where filter coefficients would be sent per image area. At the same time, local estimation of the second correlation data related to the decoded video signal only enables adapting to local characteristics of the video image, and improves the performance of filtering in case of a non-stationary video signal.

The filter coefficients calculated by the filter design units 530 and 560 as described above can be applied, for instance in H.264/AVC, to an interpolation filter, a post filter, a deblocking filter, or any other filter, such as a loop filter, and may be introduced in future into the standard or employed without being standardized.

### Embodiment 2

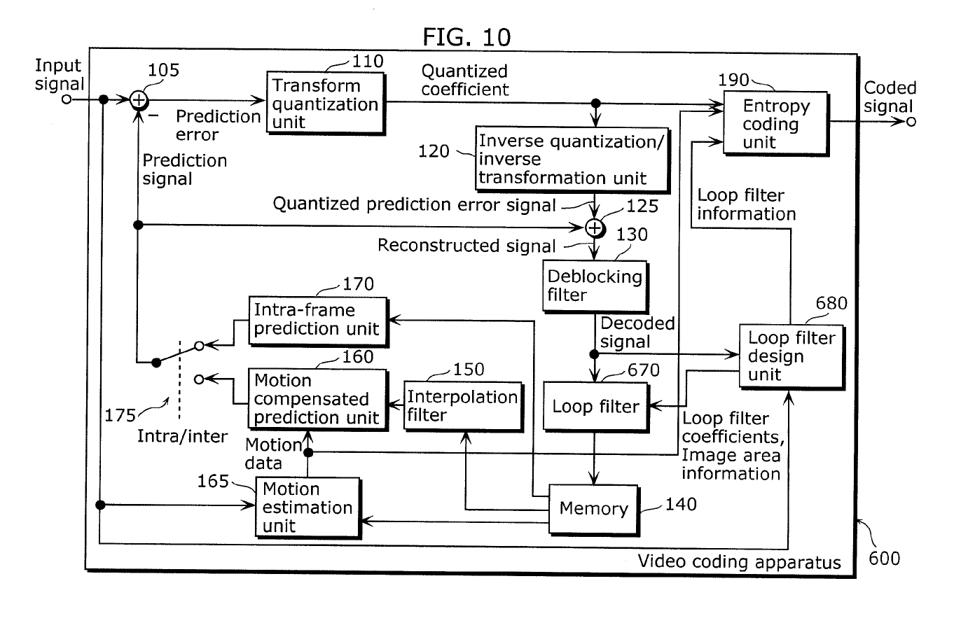

FIG. 10 illustrates a video coding apparatus 600 modified based on the H.264/AVC video coding standard, according to Embodiment 2 in the present invention.

As illustrated in FIG. 10, the video coding apparatus 600 includes a subtractor 105, a transform quantization unit 110, an inverse quantization/inverse transformation unit 120, an adder 125, a deblocking filter 130, an entropy coding unit 190, and a predicted block generation unit (not illustrated). The video coding apparatus 600 subdivides a signal to be coded into blocks, and sequentially codes the blocks. The signal to be coded represents an image.

The subtractor 105 subtracts a predicted block (prediction signal) from a block to be coded (input signal) to generate a prediction error signal. The transform quantization unit 110 performs Discrete Cosine Transformation (DCT) on the prediction error signal, quantizes the DCT-transformed prediction error signal, and generates quantized coefficients. The entropy coding unit 190 entropy codes the quantized coefficients to generate a coded signal. The entropy coding unit 190 may entropy code the motion compensation data generated by the motion estimation unit 165 and the first correlation data calculated by the loop filter design unit 680, together with the quantized coefficients.

The inverse quantization/inverse transformation unit 120 inverse quantizes the quantized coefficients, and performs an inverse DCT transformation on the inverse quantized coefficients to generate a quantized prediction error signal. The adder 125 adds the quantized prediction error signal and the predicted block to generate a reconstructed signal. The deblocking filter 130 reduces blocking artifacts from the reconstructed signal to generate a decoded signal.

A loop filter 670 filters the decoded signal using the filter coefficient and others calculated by the loop filter design unit 680. These operations lead to an improved subjective image quality of the decoded signals. The details will be described later.

The predicted block generation unit generates a predicted block obtained by predicting the block to be coded, based on an image coded prior to the block to be coded (input signal). The predicted block generation unit includes a memory 140, an interpolation filter 150, a motion compensated prediction unit 160, a motion estimation unit 165, an intra-frame prediction unit 170, and an intra/inter switch 175.

The memory 140 functions as a delay unit that temporarily stores the decoded signal filtered by the loop filter 670. More specifically, the blocks quantized by the transform quantization unit 110, inverse quantized by the inverse quantization/inverse transformation unit 120, and filtered by the deblocking filter 130 and the loop filter 670 are sequentially stored in the memory 140 to store an image (picture).

The interpolation filter 150 spatially interpolates a pixel value of the decoded signal prior to the motion compensated prediction. The motion estimation unit 165 performs a motion prediction based on the decoded signal and the next block to be coded to generate motion data (motion vector). The motion compensated prediction unit 160 performs a motion compensated prediction based on the decoded signal and the motion data to generate a predicted block.

The intra-frame prediction unit 170 intra-predicts the decoded signal to generate a prediction signal. The intra/inter switch 175 selects one of the intra-prediction mode and the inter-prediction mode as a prediction mode. Then, the predicted block provided from the intra/inter switch 175 becomes a signal for predicting the next block to be coded.

The video coding apparatus 600 in FIG. 10 differs from the conventional video coding apparatus 100 in FIG. 1 in including the loop filter design unit 680 instead of the post filter design unit 180. Furthermore, the video coding apparatus 600 includes the loop filter 670 that filters the decoded signal using the filter coefficient calculated by the loop filter design unit 680. More specifically, the loop filter design unit 680 operates as the filter design unit 530 described with reference to FIG. 5A, and includes an area forming unit 532, an estimation unit 534, and a coefficient calculation unit 536.

The loop filter design unit 680 calculates a filter coefficient based on the input signal and the decoded signal, and transmits the filter coefficient to the loop filter 670. The loop filter design unit 680 also passes information about the image area subdivision to the local loop filter 670. The loop-filtered signal is stored in the memory 140 and utilized as a reference for prediction of images to be coded later. In this example, the decoded video signal and the input video signal used for the loop filter design are in the pixel domain, i.e., represent pixel values of a video signal. However, the loop filter 670 and/or the loop filter design unit 680 may also work with a prediction error signal and correspondingly with a quantized prediction error signal. It should be noted that even if the loop filter 670 is applied instead of the post filter 280 in this example, in general it may be an advantage to keep also the post filter 280.

The loop filter information provided for a video decoding apparatus 700 in Embodiment 2 includes the first correlation data determined by the estimation unit 534 of the loop filter design unit 680. As described above, this first correlation data is based on both the input video signal and the decoded video signal, and may include, for instance, the cross correlation vector or its parts, such as an autocorrelation of noise defined as a difference between an input video signal and a decoded video signal.

Here, the entropy coding unit 190 entropy codes the loop filter information in order to reduce the overhead necessary for its signaling, together with the quantized coefficient and the motion data. The entropy code used for its coding does not necessarily correspond to any of entropy codes used in H.264/AVC to code the information elements related to a coded video signal or the side information necessary for its decoding. The entropy code may be any variable length codes, such as an integer code such as a Golomb code, an exponential Golomb code, a unitary code, and an Elias code. The assignment of code words to values of the correlation data may be reordered in accordance with the probability of their occurrence. Specially designed or context adaptive entropy codes such as a Huffman code, a Shannon-Fano code, and an arithmetic code may also be used. Alternatively, the correlation data may be transmitted using a fixed length code.

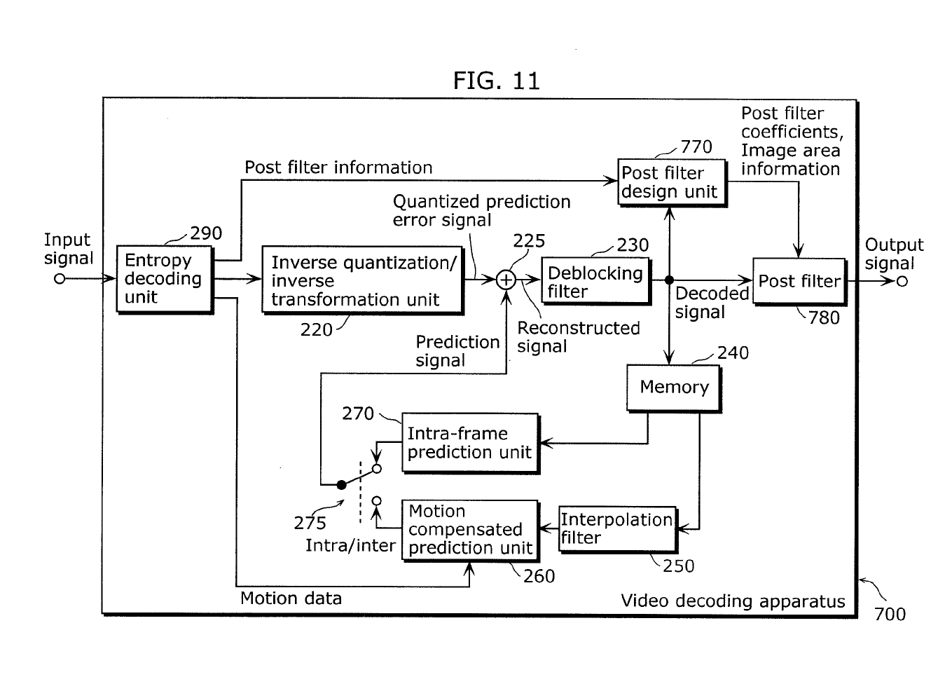

FIG. 11 shows a block illustration of the video decoding apparatus 700 with post filtering according to Embodiment 2 in the present invention.

As illustrated in FIG. 11, the video decoding apparatus 700 includes an entropy decoding unit 290, an inverse quantization/inverse transformation unit 220, an adder 225, a deblocking filter 230, a post filter design unit 770, a post filter 780, and a predicted block generation unit (not illustrated). The video decoding apparatus 700 decodes the coded signal coded by the video coding apparatus 600 in FIG. 10 to generate a decoded block (decoded signal).

The entropy decoding unit 290 entropy decodes the coded signal (input signal) provided from the video coding apparatus 600 to obtain the quantized coefficient, the motion data, and the first correlation data.

The post filter 780 is, for example, a Wiener filter to be applied to a decoded signal using a filter coefficient calculated by the post filter design unit 770, and improves the subjective image quality of an image. The details will be described later.

The predicted block generation unit includes a memory 240, an interpolation filter 250, a motion compensated prediction unit 260, an intra-frame prediction unit 270, and an intra/inter switch 275. Although the predicted block generation unit has the basic configuration and operations in common with the one in FIG. 10, it omits the motion estimation unit 165 and differs in obtaining the motion data from the entropy decoding unit 290.

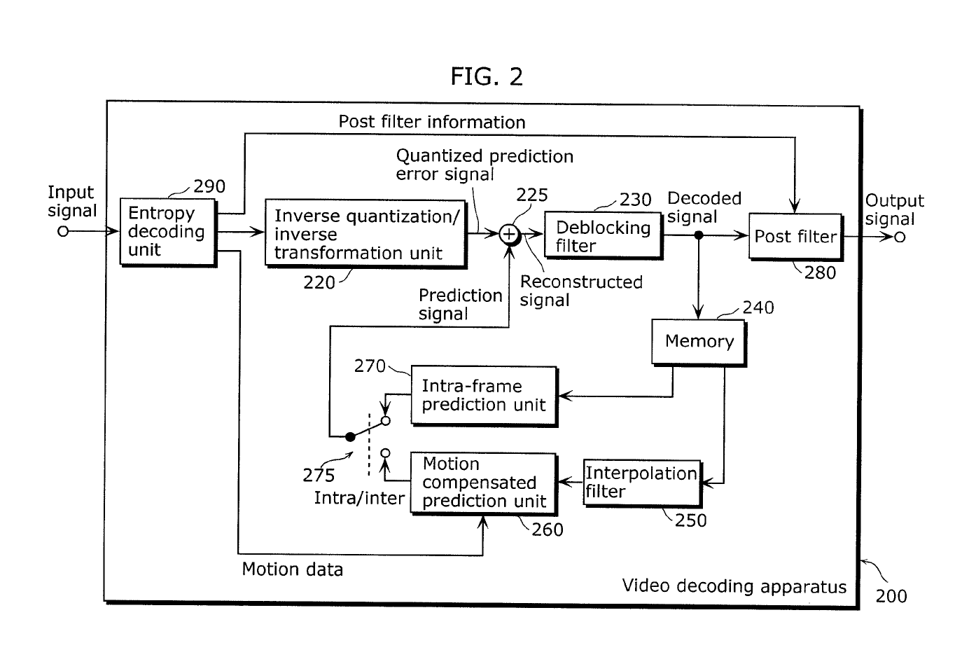

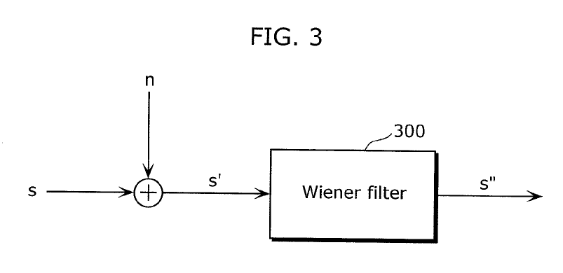

The video decoding apparatus 700 in FIG. 11 further differs from the conventional video decoding apparatus 200 in FIG. 2 in including the post filter design unit 770.

The post filter design unit 770 operates as the filter design unit 560 described with reference to FIG. 6A, and includes an area forming unit 562, an estimation unit 564, and a coefficient calculation unit 566. Based on the signalized post filter information including the first correlation data (and possibly image area information) and based on the decoded video signal, in the post filter design unit 770, the area forming unit 562 determines an image area, the estimation unit 564 estimates the local correlation data, and the coefficient calculation unit 566 calculates the filter coefficient based on a result of the estimation. The filter coefficient is then provided to the post filter 780 together with the image area information for local filtering. The image area information indicates the image area to which the filter coefficient shall be applied.

The video decoding apparatus 700 in FIG. 11 may include a loop filter design unit and a loop filter, instead of the post filter design unit 770 and the post filter 780, or in addition to the post filter design unit 770 and the post filter 780. The loop filter design unit performs the same processing as the loop filter design unit 680 in FIG. 10 other than the process of obtaining the first correlation data from the video coding apparatus 600. Furthermore, the loop filter performs the same processing as the loop filter 670 in FIG. 10.

### Embodiment 3

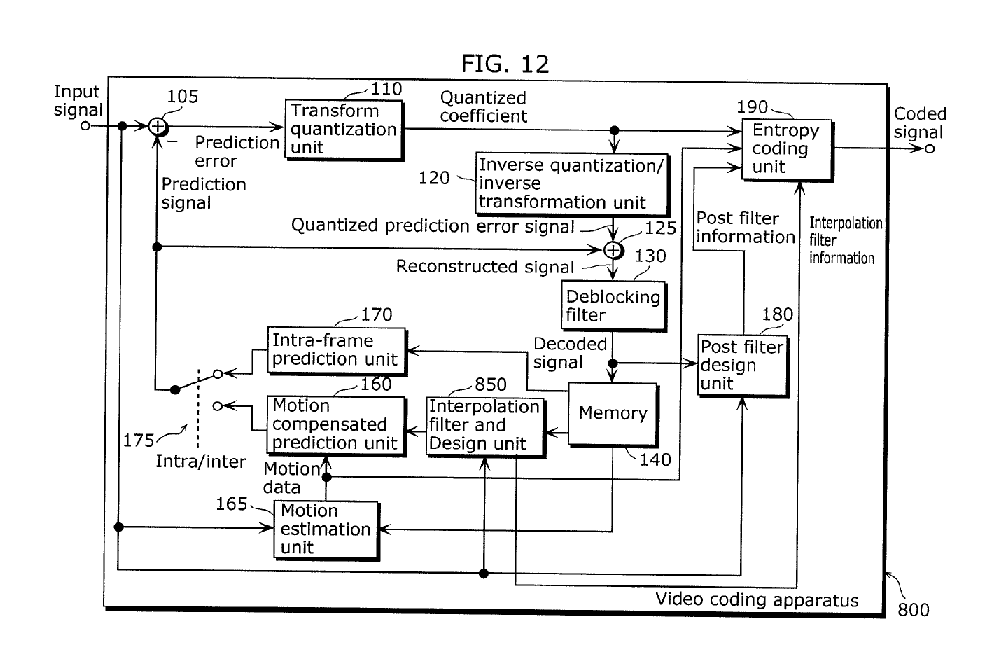

According to further Embodiment 3 in the present invention, a video coding apparatus 800 and a video decoding apparatus 900 each with an interpolation filter are provided. FIG. 12 illustrates the video coding apparatus 800 including an interpolation filter and design unit 850. The description of the commonalities with each of Embodiments will be omitted, and the differences will be mainly described hereinafter.

The interpolation filter and design unit 850 operates and includes the same configuration, as the filter design unit 530 described with reference to FIG. 5A. Furthermore, the interpolation filter and design unit 850 operates and includes the same configuration, as the interpolation filter 150 described with reference to FIG. 10. In other words, the interpolation filter and design unit 850 performs interpolation filtering on a decoded signal, and calculates a filter coefficient used by itself.

The locally determined correlation data determined by the interpolation filter and design unit 850 is used for filter design, and a part of the correlation data is passed to the entropy coding unit 190 to be provided for the video decoding apparatus 900. Again, the entropy code used for coding the correlation data may be similar to one of the entropy code and the post filter information that are used for H.264/AVC data. However, it may be an advantage to design the entropy code adapted to the characteristics of this data separately.

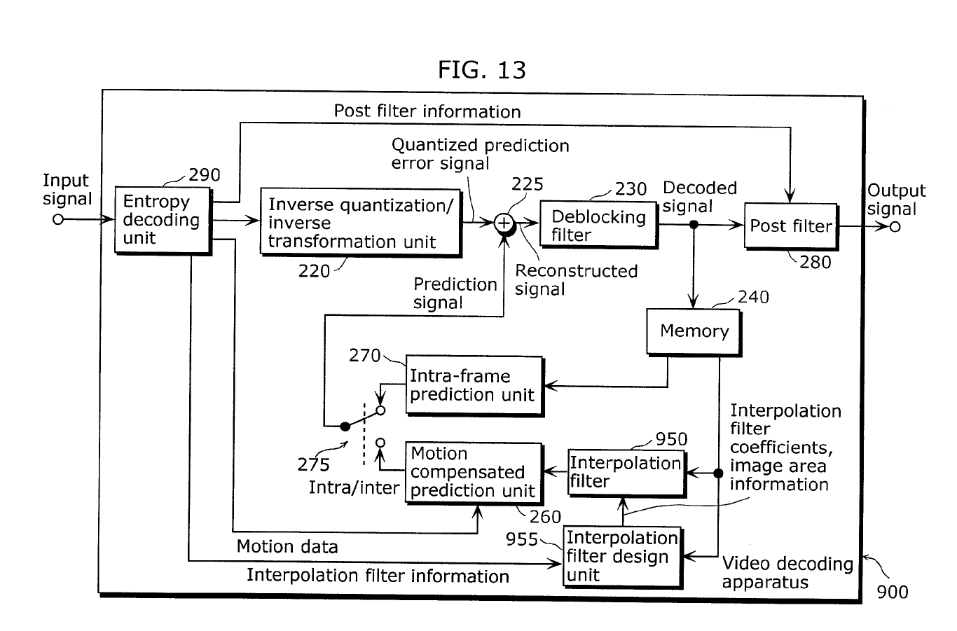

FIG. 13 illustrates the video decoding apparatus 900 with an interpolation filter design unit 955 working in a similar way as the filter design unit 560 described with reference to FIG. 6A. The description of the commonalities with each of Embodiments will be omitted, and the differences will be mainly described hereinafter.

The interpolation filter design unit 955 operates and includes the same configuration, as the filter design unit 560 described with reference to FIG. 5B. In other words, the interpolation filter design unit 955 determines the local filter coefficient based on the interpolation filter information including the first correlation data and based on the decoded video signal data from the memory 240, and provides the determined local filter coefficient to an interpolation filter 950, together with the image area information. The interpolation filter 950 uses the information obtained from the interpolation filter design unit 955 to filter the decoded local (image area) video signal obtained from the memory 240.

The deblocking filter 130 of the video coding apparatus 800 as well as the deblocking filter 230 of the video decoding apparatus 900 may also be employed according to an implementation of the present invention, i.e. adaptively to the local image characteristics and under control according to the correlation information.

Both embodiments of the video coding apparatuses 600 and 800 and the video decoding apparatuses 700 and 900 that are described with reference to FIGS. 10 to 13 may be combined. Furthermore, a video coding apparatus and a video decoding apparatus with a locally adaptive loop filter and/or a post filter as well as an interpolation filter may be employed. A common filter design unit may then be used to perform similar operations (area forming, estimation, coefficients calculation) based on different input data.

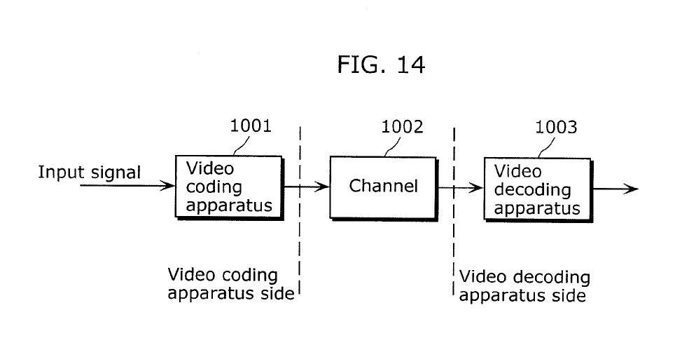

FIG. 14 illustrates a system for transferring a video signal from a video coding apparatus 1001 side to a video decoding apparatus 1003 side. An input image signal is coded by a video coding apparatus 1001 and provided to a channel 1002. As described above, the video coding apparatus 1001 is a video coding apparatus according to any of the embodiments of the present invention.

The channel 1002 is either a storage unit or any transmission channel. The storage unit may be, for instance, any volatile or non-volatile memory, any magnetic or optical medium, and a mass-storage unit. The transmission channel may be formed by physical resources of any transmission system, wireless or wired, fixed or mobile, such as xDSL, ISDN, WLAN, GPRS, UMTS, Internet, or any standardized or proprietary system.

Other than the coding unit, the video coding apparatus 1001 may also include a format converter for transmitting the coded video signal over the channel 1002, a unit for preprocessing of the input video signal such as a transmitter, and an application for transferring the coded video signal into a recording medium. The coded video signal is then obtained by the video decoding apparatus 1003 through the channel 1002.

As described above, the video decoding apparatus 1003 is a video decoding apparatus according to any of the embodiments of the present invention. The video decoding apparatus 1003 decodes the coded video signal. Other than the decoding unit, the video decoding apparatus 1003 may further include a receiver for receiving the coded video signal from a transmission channel, an application for extracting the coded video data from the storage, and a post-processing unit for post processing of the decoded video signal, such as format conversion.

Another embodiment of the present invention relates to the implementation of the above described various embodiments using hardware and software. It is recognized that the various embodiments of the present invention may be implemented or performed using computing devices (processors). The computing devices or processors may for example be general purpose processors, digital signal processors (DSP), application specific integrated circuits (ASIC), field programmable gate arrays (FPGA), or other programmable logic devices. The various embodiments of the present invention may also be performed or embodied by a combination of these devices.

Further, the various embodiments of the present invention may also be implemented by means of software modules which are executed by a processor or directly in hardware Also, a combination of the software modules and a hardware implementation may be possible. The software modules may be stored on any kind of computer readable storage media, for example, RAM, EPROM, EEPROM, flash memory, registers, hard disks, CD-ROM, and DVD.

Most of the examples have been outlined in relation to the H.264/AVC based video coding system, and the terminology mainly relates to the H.264/AVC terminology. However, this terminology and the description of the various embodiments with respect to the H.264/AVC based coding is not intended to limit the principles and ideas of the present invention to such systems. Also the detailed explanations of the coding and decoding in compliance with the H.264/AVC standard are intended to better understand the exemplary embodiments described herein and should not be understood as limiting the present invention to the described specific implementations of processes and functions in the video coding. Nevertheless, the improvements proposed herein may be readily applied in the video coding described. Furthermore the concept of the present invention may be also readily used in the enhancements of H.264/AVC coding currently discussed by the MT.

Summarizing, the present invention provides a method of coding, a method of decoding, an apparatus for coding, and an apparatus for decoding a video signal using locally adaptive filtering controlled by local correlation data. First, correlation data is estimated by the video coding apparatus and provided to the video decoding apparatus. The estimation is performed based on the input video signal and on the decoded video signal. Moreover, an image area that is a part of a video frame is determined, and second correlation data is estimated for the determined image area, based on the decoded video signal. The first and the second correlation data are then employed for calculation of the filter coefficients. The image area is filtered according to the locally determined filter coefficients. Coding and decoding processes according to an implementation of the present invention enable adapting the filtering to the local characteristics of the video images, and improve thus the performance of the filtering. As the first correlation data does not need to be submitted for each image area, the coding efficiency is also improved.

### Embodiment 4

The processing described in Embodiments can be simply implemented by an independent computer system, by recording, in a recording medium, a program for implementing the configurations for the video coding method and the video decoding method described in Embodiments. The recording media may be any recording media as long as the program can be recorded, such as a magnetic disk, an optical disk, a magnetic optical disk, an IC card, and a semiconductor memory.

Hereinafter, the applications to the video coding method and the video decoding method described in Embodiments and systems using thereof will be described.

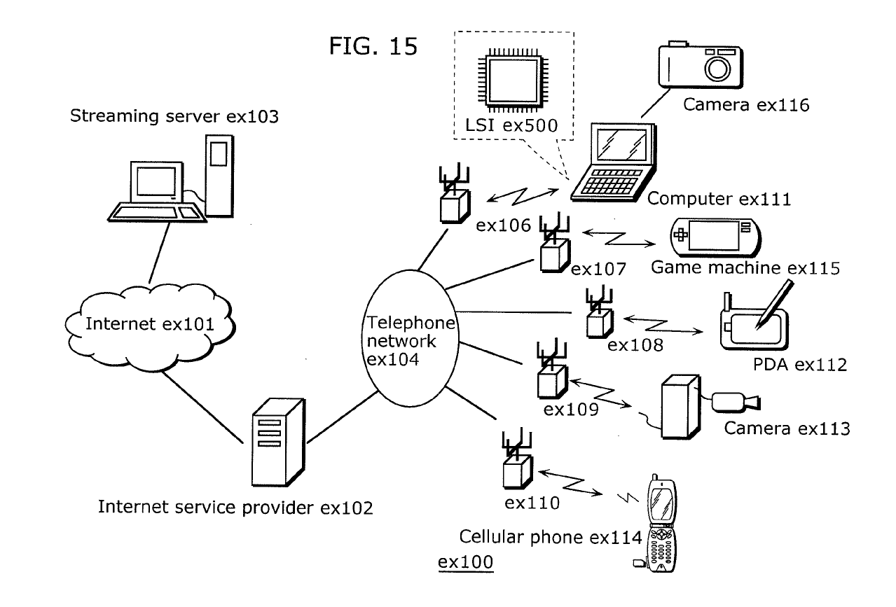

FIG. 15 illustrates an overall configuration of a content providing system ex100 for implementing content distribution services. The area for providing communication services is divided into cells of desired size, and base stations ex106 to ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 15, and a combination in which any of the elements are connected is acceptable. In addition, each of the devices may be directly connected to the telephone network ex104, rather than via the base stations ex107 to ex110 which are the fixed wireless stations. Furthermore, the devices may be interconnected to each other via a short distance wireless communication and others.

The camera ex113, such as a digital video camera, is capable of capturing moving images. A camera ex116, such as a digital video camera, is capable of capturing both still images and moving images. Furthermore, the cellular phone ex114 may be the one that meets any of the standards such as Global System for Mobile Communications (GSM), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. For such a distribution, a content (for example, video of a music live show) captured by the user using the camera ex113 is coded as described above in Embodiments, and the coded content is transmitted to the streaming server ex103. On the other hand, the streaming server ex103 carries out stream distribution of the received content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data.

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and moving images captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the video data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients can receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

When each of the devices included in the content providing system performs coding and decoding, the image coding method and the image decoding method shown in each of Embodiments may be used.

The cellular phone ex114 will be described as an example of such a device.

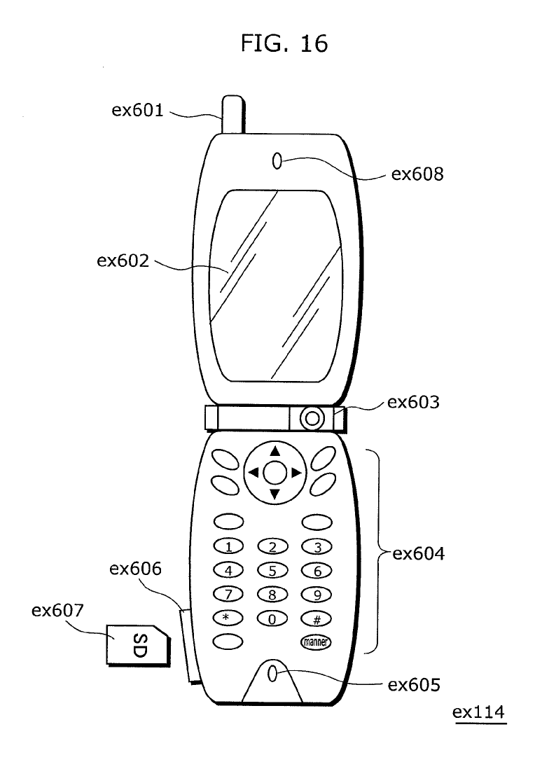

FIG. 16 illustrates the cellular phone ex114 that uses the image coding method and the image decoding method described in Embodiment 4. The cellular phone ex114 includes: an antenna ex601 for transmitting and receiving radio waves through the base station ex110; a camera unit ex603 such as a CCD camera capable of capturing moving and still images; a display unit ex602 such as a liquid crystal display for displaying the data such as decoded video captured by the camera unit ex603 or received by the antenna ex601; a main body unit including a set of operation keys ex604; an audio output unit ex608 such as a speaker for output of audio; an audio input unit ex605 such as a microphone for input of audio; a recording medium ex607 for recording coded or decoded data including data of captured moving or still pictures, data of received e-mails, and data of moving or still pictures; and a slot unit ex606 for enabling the cellular phone ex115 to attach the recording medium ex607. The recording medium ex607 includes, within a plastic case, a flash memory element that is one type of Electrically Erasable and Programmable Read-Only Memory (EEPROM) which is a non-volatile memory that is electrically rewritable and erasable, for example, an SD Card.

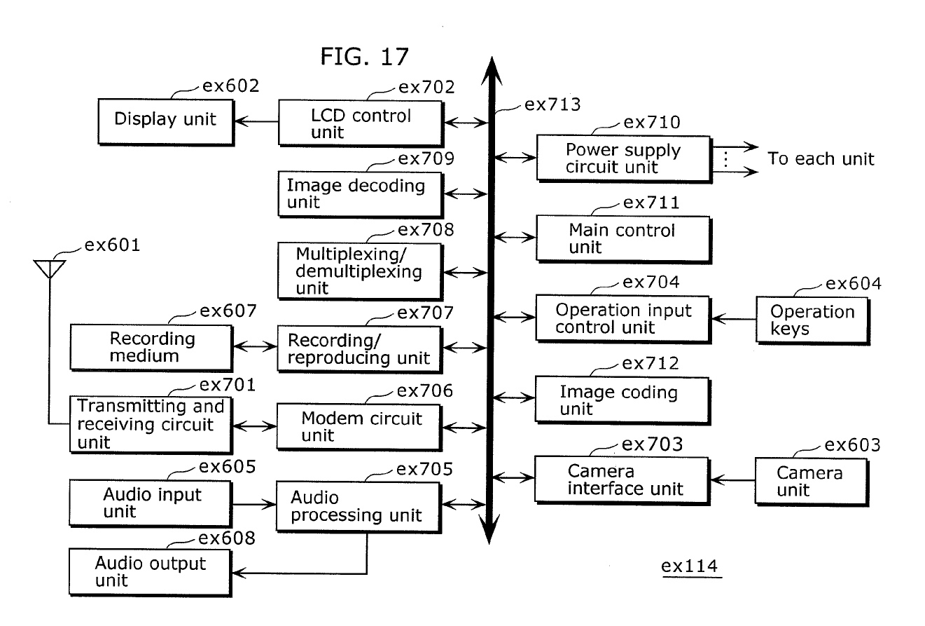

Next, the cellular phone ex114 will be described with reference to FIG. 17. In the cellular phone ex114, a main control unit ex711 designed to control overall each unit of the main body including the display unit ex602 as well as the operation keys ex604 is connected mutually, via a synchronous bus ex713, to a power supply circuit unit ex710, an operation input control unit ex704, an image coding unit ex712, a camera interface unit ex703, a liquid crystal display (LCD) control unit ex702, an image decoding unit ex709, a multiplexing/demultiplexing unit ex708, a recording/reproducing unit ex707, a modem circuit unit ex706, and an audio processing unit ex705.

When a call-end key or a power key is turned ON by a user's operation, the power supply circuit unit ex710 supplies the respective units with power from a battery pack so as to activate the cell phone ex114 that is digital and is equipped with the camera.

In the cellular phone ex114, the audio processing unit ex705 converts the audio signals collected by the audio input unit ex605 in voice conversation mode into digital audio data under the control of the main control unit ex711 including a CPU, ROM, and RAM. Then, the modem circuit unit ex706 performs spread spectrum processing on the digital audio data, and the transmitting and receiving circuit unit ex701 performs digital-to-analog conversion and frequency conversion on the data, so as to transmit the resulting data via the antenna ex601. In addition, in the cellular phone ex114, the transmitting and receiving circuit unit ex701 amplifies the data received by the antenna ex601 in voice conversation mode and performs frequency conversion and the analog-to-digital conversion on the data. Then, the modem circuit unit ex706 performs inverse spread spectrum processing on the data, and the audio processing unit ex705 converts it into analog audio data, so as to output it via the audio output unit ex608.

Furthermore, when an e-mail in data communication mode is transmitted, text data of the e-mail inputted by operating the operation keys ex604 of the main body is sent out to the main control unit ex711 via the operation input control unit ex704. The main control unit ex711 causes the modem circuit unit ex706 to perform spread spectrum processing on the text data, and the transmitting and receiving circuit unit ex701 performs the digital-to-analog conversion and the frequency conversion on the resulting data to transmit the data to the base station ex110 via the antenna ex601.

When image data is transmitted in data communication mode, the picture data captured by the camera unit ex603 is supplied to the image coding unit ex712 via the camera interface unit ex703. When the image data is not transmitted, the image data captured by the camera unit ex603 can be displayed directly on the display unit ex602 via the camera interface unit ex703 and the LCD control unit ex702.

The image coding unit ex712 including the image coding apparatus as described for the present invention compresses and codes the image data supplied from the camera unit ex603 using the coding method employed by the image coding apparatus as shown in Embodiments so as to transform the data into coded picture data, and sends the data out to the multiplexing/demultiplexing unit ex708. Here, the cellular phone ex114 simultaneously sends out, as digital audio data, the audio received by the audio input unit ex605 during the capturing with the camera unit ex603 to the multiplexing/demultiplexing unit ex708 via the audio processing unit ex705.

The multiplexing/demultiplexing unit ex708 multiplexes the coded image data supplied from the picture coding unit ex712 and the audio data supplied from the audio processing unit ex705, using a predetermined method. Then, the modem circuit unit ex706 performs spread spectrum processing on the multiplexed data obtained from the multiplexing/demultiplexing unit ex708. After the digital-to-analog conversion and frequency conversion on the data, the transmitting and receiving circuit unit ex701 transmits the resulting data via the antenna ex601.

When receiving data of a video file which is linked to a Web page and others in data communication mode, the modem circuit unit ex706 performs inverse spread spectrum processing on the data received from the base station ex110 via the antenna ex601, and sends out the multiplexed data obtained as a result of the inverse spread spectrum processing to the multiplexing/demultiplexing unit ex708.

In order to decode the multiplexed data received via the antenna ex601, the multiplexing/demultiplexing unit ex708 demultiplexes the multiplexed data into a bit stream of video data and that of audio data, and supplies the coded video data to the image decoding unit ex709 and the audio data to the audio processing unit ex705, respectively via the synchronous bus ex713.

Next, the image decoding unit ex709 including the image decoding apparatus as described for the present invention decodes the bit stream of the image data using the decoding method corresponding to the coding method as shown in Embodiments so as to generate reproduced video data, and supplies this data to the display unit ex602 via the LCD control unit ex702. Thus, the video data included in the video file linked to the Web page, for instance, is displayed. Simultaneously, the audio processing unit ex705 converts the audio data into analog audio data, and supplies the data to the audio output unit ex608. Thus, the audio data included in the video file linked to the Web page, for instance, is reproduced.

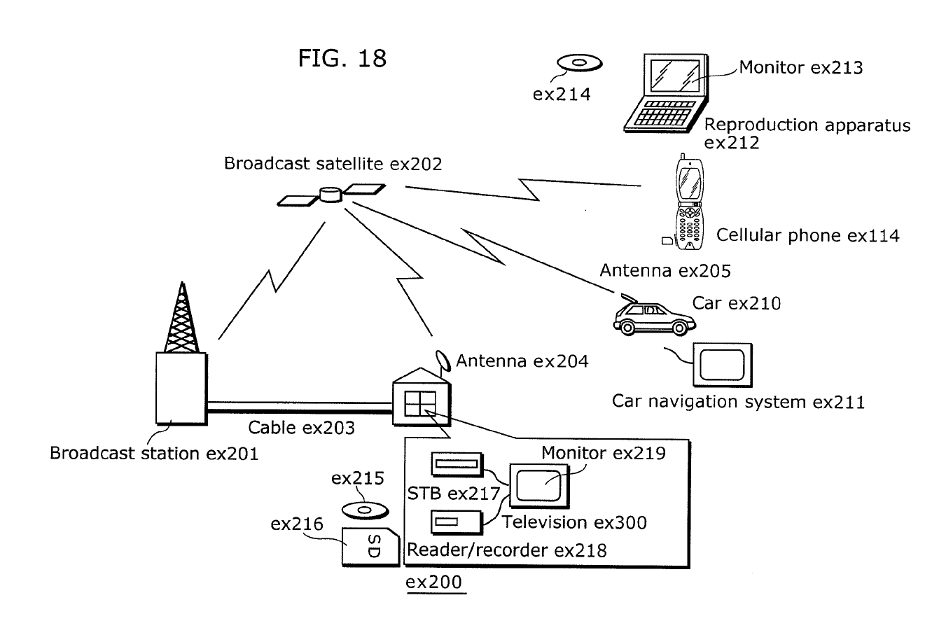

The present invention is not limited to the above-mentioned system because terrestrial or satellite digital broadcasting has been in the news lately, and at least either the image coding apparatus or the image decoding apparatus described in Embodiments can be incorporated into a digital broadcasting system as shown in FIG. 18. More specifically, a broadcast station ex201 communicates or transmits, via radio waves to a broadcast satellite ex202, audio data, video data, or a bit stream obtained by multiplexing the audio data or the video data. Upon receipt of the bit stream, the broadcast satellite ex202 transmits radio waves for broadcasting. Then, a home-use antenna ex204 with a satellite broadcast reception function receives the radio waves, and a device, such as a television (receiver) ex300 and a set top box (STB) ex217 decodes a coded bit stream and reproduces the decoded bit stream. Furthermore, a reader/recorder ex218 that reads and decodes such a bit stream obtained by multiplexing video data and audio data that are recorded on recording media ex215 and 216, such as a CD and a DVD can include the image decoding apparatus as shown in Embodiments. In this case, the reproduced video signals are displayed on a monitor ex219. It is also possible to implement the image decoding apparatus in the set top box ex217 connected to a cable ex203 for a cable television or an antenna ex204 for satellite and/or terrestrial broadcasting, so as to reproduce the video signals on the monitor ex219 of the television ex300. The image decoding apparatus may be included not in the set top box but in the television ex300. Also, a car ex210 having an antenna ex205 can receive signals from the satellite ex202 or the base station ex201 for reproducing video on a display device such as a car navigation system ex211 set in the car ex210.

Furthermore, the video decoding apparatus or the video coding apparatus as shown in Embodiments can be implemented in the reader/recorder ex218 (i) for reading and decoding the coded bit stream obtained by multiplexing the video data and the audio data that are recorded on the recording medium ex215, such as a BD and a DVD, or (ii) for coding the video data and the audio data on the recording medium ex215 and recording the resulting data as the multiplexed data. In this case, the reproduced video signals are displayed on the monitor ex219, and can be reproduced by another device or system using the recording medium ex215 on which the coded bit stream is recorded. It is also possible to implement the image decoding apparatus in the set top box ex217 connected to the cable ex203 for a cable television or to the antenna ex204 for satellite and/or terrestrial broadcasting, so as to display the video signals on the monitor ex219 of the television ex300. The video decoding apparatus may be implemented not in the set top box but in the television ex300.

Furthermore, the video decoding apparatus or the video coding apparatus as shown in Embodiments can be implemented in the reader/recorder ex218 (i) for reading and decoding the video data, the audio data, or the coded bit stream obtained by multiplexing the video data and the audio data, or (ii) for coding the video data, the audio data, or the coded bit stream obtained by multiplexing the video data and the audio data on the recording medium ex215 and recording the resulting data as the multiplexed data. Here, the video data and the audio data that are recorded on the recording medium ex215, such as a BD and a DVD. In this case, the reproduced video signals are displayed on the monitor ex219, and can be reproduced by another device or system using the recording medium ex215 on which the coded bit stream is recorded. It is also possible to implement the video decoding apparatus in the set top box ex217 connected to the cable ex203 for a cable television or the antenna ex204 for satellite and/or terrestrial broadcasting, so as to display the video signals on the monitor ex219 of the television ex300. The video decoding apparatus may be implemented not in the set top box but in the television ex300.

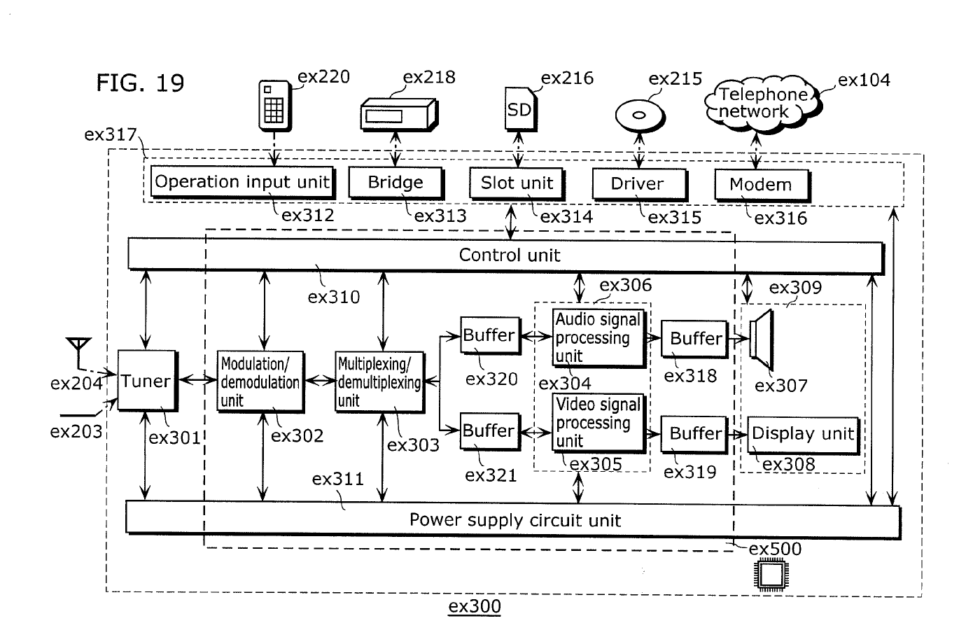

FIG. 19 illustrates the television (receiver) ex300 that uses the video coding method and the video decoding method described in each of Embodiments. The television ex300 includes: a tuner ex301 that obtains or provides a bit stream of video information from and through the antenna ex204 or the cable ex203, etc. that receives a broadcast; a modulation/demodulation unit ex302 that demodulates the received coded data or modulates data into coded data to be supplied outside; and a multiplexing/demultiplexing unit ex303 that demultiplexes the modulated data into video data and audio data, or multiplexes the coded video data and audio data into data. The television ex300 further includes: a signal processing unit ex306 including an audio signal processing unit ex304 and a video signal processing unit ex305 that decode audio data and video data and code audio data and video data, respectively; and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, a configuration in which the television ex300 decodes data obtained from outside through the antenna ex204 and others and reproduces the decoded data will be described. In the television ex300, upon a user operation through a remote controller ex220 and others, the multiplexing/demultiplexing unit ex303 demultiplexes the video data and audio data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of Embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the c read a coded bit stream not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method as shown in Embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318 to ex321 may be plural as illustrated, or at least one buffer may be shared in the television ex300. Furthermore, data may be stored in a buffer other than the buffers ex318 to ex321 so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes a coded bit stream from or in a recording medium, one of the television ex300 and the reader/recorder ex218 may decode or code the coded bit stream, and the television ex300 and the reader/recorder ex218 may share the decoding or coding.

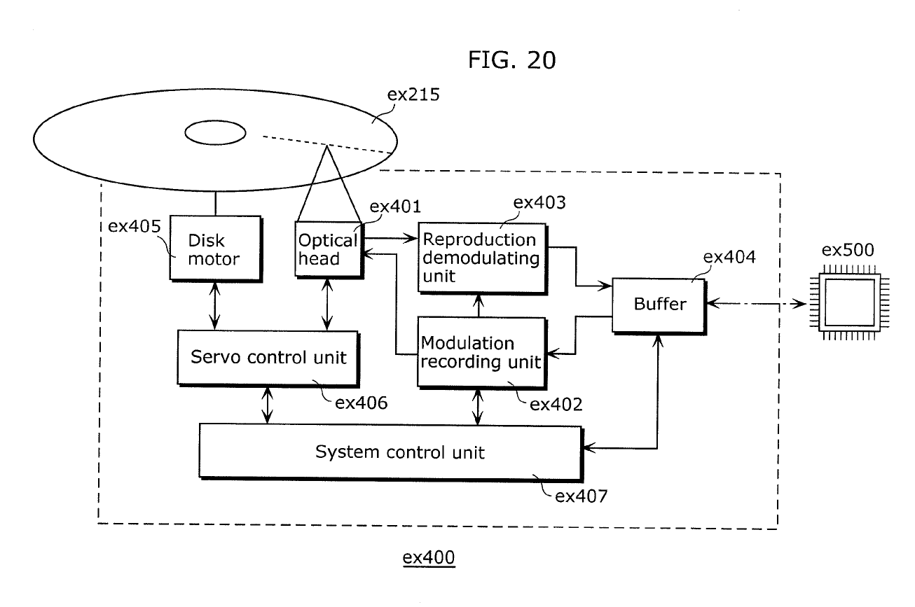

As an example, FIG. 20 illustrates a configuration of an information reproducing/recording unit ex400 when data is read or written from or in an optical disk. The information reproducing/recording unit ex400 includes constituent elements ex401 to ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. A disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

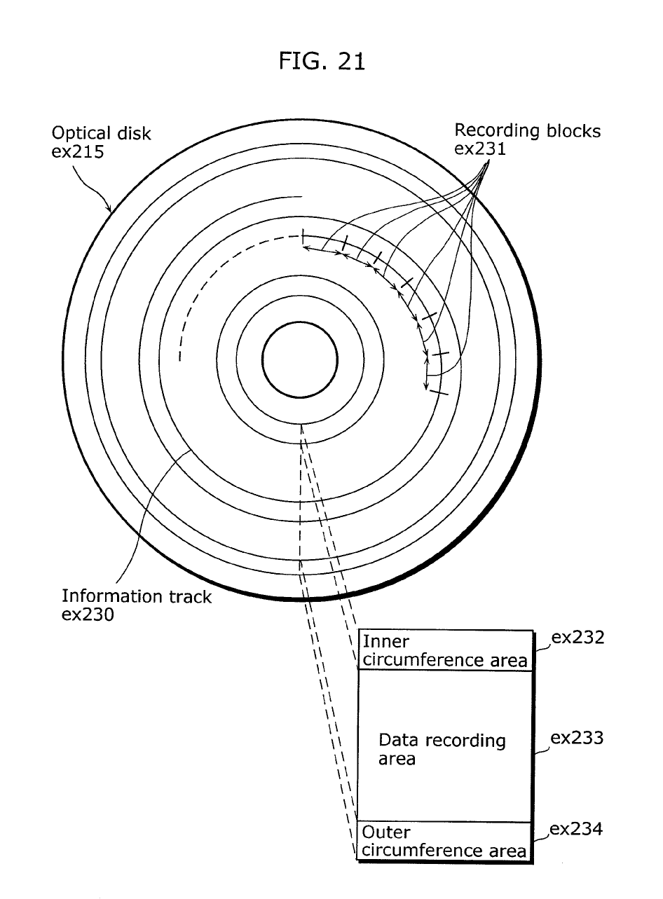

FIG. 21 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or coded data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, the car ex210 having the antenna ex205 can receive data from the satellite ex202 and others, and reproduce video on the display device such as the car navigation system ex211 set in the car ex210, in a digital broadcasting system ex200. Here, a configuration of the car navigation system ex211 will be a configuration, for example, including a GPS receiving unit from the configuration illustrated in FIG. 19. The same will be true for the configuration of the computer ex111, the cellular phone ex114, and others. Furthermore, similarly to the television ex300, a terminal such as the cellular phone ex114 may have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus.

As such, the video coding method and the video decoding method in each of Embodiments can be used in any of the devices and systems described. Thus, the advantages described in each of Embodiments can be obtained.

Furthermore, the present invention is not limited to Embodiments, and various modifications and revisions are possible without departing from the scope of the present invention.

### Embodiment 5

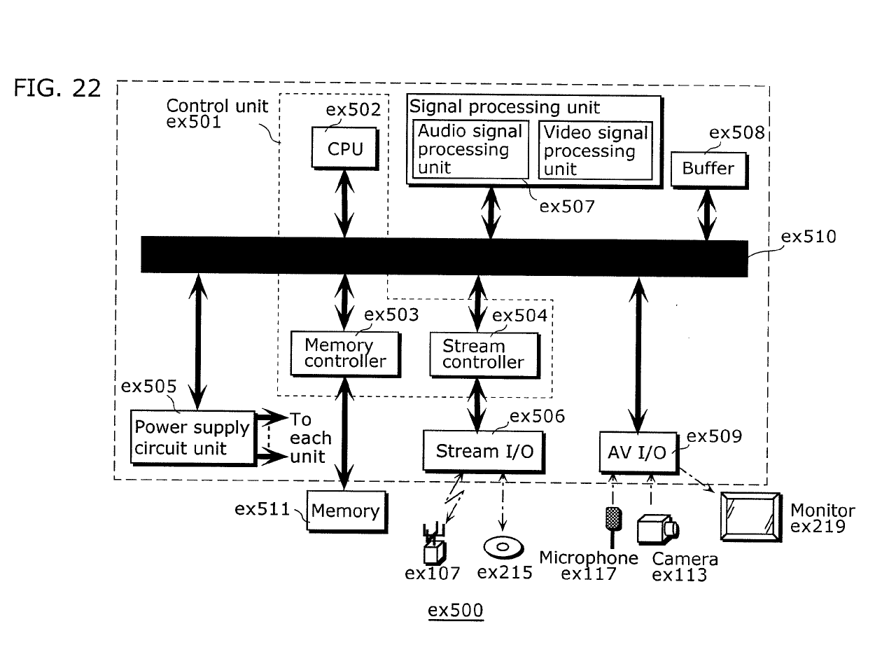

Each of the video coding method, the video coding apparatus, the video decoding method, and the video decoding apparatus in each of Embodiments is typically achieved in the form of an integrated circuit or a Large Scale Integrated (LSI) circuit. As an example of the LSI, FIG. 22 illustrates a configuration of the LSI ex500 that is made into one chip. The LSI ex500 includes elements ex501 to ex509 to be described below, and the elements are connected to each other through a bus ex510. The power supply circuit unit ex505 is activated by supplying each of the elements with power when power is on

For example, when coding is performed, the LSI ex500 receives an AV signal from a microphone ex117, a camera ex113, and others through an AV IO ex509 under control of a control unit ex501 including a CPU ex502, a memory controller ex503, and a stream controller ex504. The received AV signal is temporarily stored in a memory ex511 outside the LSI ex500, such as an SDRAM. Under control of the control unit ex501, the stored data is subdivided into data portions according to the processing amount and speed in and at which the data is to be transmitted to a signal processing unit ex507 as necessary. Then, the signal processing unit ex507 codes an audio signal and/or a video signal. Here, the coding of the video signal is the coding described in each of Embodiments. Furthermore, the signal processing unit ex507 sometimes multiplexes the coded audio data and the coded video data, and a stream I/O ex506 provides the multiplexed data outside. The provided bit stream is transmitted to the base station ex107, or written on the recording medium ex215. When data sets are multiplexed, the data should be temporarily stored in the buffer ex508 so that the data sets are synchronized with each other.

For example, when coded data is decoded, the LSI ex500 temporarily stores, in the memory ex511, the coded data read from the base station ex107 or the recording medium ex215 through the stream I/O ex506 under control of the control unit ex501. Under control of the control unit ex501, the stored data is subdivided into data portions according to the processing amount and speed in and at which the data is to be transmitted to a signal processing unit ex507 as necessary. Then, the signal processing unit ex507 decodes audio data and/or video data. Here, the decoding of the video signal is the decoding described in each of Embodiments. Furthermore, a decoded audio signal and a decoded video signal may be temporarily stored in the buffer ex508 and others so that the signals can be reproduced in synchronization with each other. Each of the output units, such as the cellular phone ex114, the game machine ex115, and the television ex300 provides the decoded output signal through the memory 511 as necessary.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSI or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. The possibility is that the present invention is applied to biotechnology.

Although Embodiments of the present invention are described with reference to the drawings, the present invention is not limited to Embodiments and the drawings. Various modifications and revisions to Embodiments and the drawings are possible within the scope of the present invention or within the scope of equivalents of the present invention. Furthermore, any combinations of each of Embodiments is acceptable.

### INDUSTRIAL APPLICABILITY

The present invention is advantageously used as an image coding method and an image decoding method.

### REFERENCE SIGNS LIST

100, 500, 600, 800, 1001 Video coding apparatus

105 Subtractor

110 Transform quantization unit

120, 220 Inverse quantization/inverse transformation unit

125, 225 Adder

130, 230 Deblocking filter

140, 240 Memory

150, 250, 950 Interpolation filter

160, 260 Motion compensated prediction unit

165 Motion estimation unit

170, 270 Intra-frame prediction unit

175, 275 Intra/inter switch

180, 770 Post filter design unit

190 Entropy coding unit

200, 501, 700, 900, 1003 Video decoding apparatus

280, 780 Post filter

290 Entropy decoding unit

300 Wiener filter

400 Video frame

401 Block

410a, 410b, 410c, 410d Image area

510 Coding unit

520, 550 Decoding unit

530, 560 Filter design unit

532, 562 Area forming unit

534, 564 Estimation unit

536, 566 Coefficient calculation unit

540, 570 Filter

670 Loop filter

680 Loop filter design unit

850 Interpolation filter and design unit

955 Interpolation filter design unit

1002 Channel

1. An image coding method of coding a signal to be coded that represents an image, said method comprising:
quantizing the signal to be coded to determine a quantized coefficient;
inverse quantizing the quantized coefficient to generate a decoded signal;
subdividing the decoded signal into image areas;
estimating (i) first correlation data for each area larger than one of the image areas determined in said subdividing, and (ii) second correlation data for each of the image areas determined in said subdividing, the first correlation data indicating a correlation between the signal to be coded and the decoded signal, and the second correlation data indicating an autocorrelation of the decoded signal;
calculating a filter coefficient using the first correlation data and the second correlation data for each of the image areas;
filtering the decoded signal for each of the image areas, using the filter coefficient calculated in said calculating; and
providing only the first correlation data from the first correlation data and the second correlation data.

2. The image coding method according to claim 1,
wherein in said calculating, the filter coefficient is calculated based on (i) a cross correlation vector between the signal to be coded and the decoded signal and (ii) an autocorrelation matrix of the decoded signal,
the cross correlation vector includes a first part indicating the autocorrelation of the decoded signal, and a second part indicating an autocorrelation of quantization noise,
the first correlation data includes only the second part from the first part and the second part, and
the second correlation data includes the first part and the autocorrelation matrix.

3. The image coding method according to claim 1,
wherein said image coding method is a method of subdividing the signal to be coded into blocks, and coding the subdivided signal to be coded for each of the blocks, and
in said subdividing, the decoded signal is subdivided into the image areas based on at least one of a quantization step size, a prediction type, and a motion vector that are determined for each of the blocks.

4. The image coding method according to claim 3,
wherein at least one of a deblocking filter process, a loop filter process, and an interpolation filter process is performed in said filtering, the deblocking filter process being for reducing blocking artifacts occurring in a boundary between the blocks that are adjacent to each other, the loop filter process being for improving a subjective image quality of the decoded signal, and the interpolation filter process being for spatially interpolating a pixel value of the decoded signal.

5. The image coding method according to claim 1,
wherein in said estimating, the first correlation data is calculated for each of signals to be coded including the signal to be coded.

6. The image coding method according to claim 1,
wherein said providing includes providing a coded signal by entropy coding the quantized coefficient and the first correlation data.

7. An image decoding method of decoding a coded signal, said method comprising:
obtaining a quantized coefficient, and first correlation data indicating a correlation between a signal to be coded and a decoded signal;
inverse quantizing the quantized coefficient to generate the decoded signal;
subdividing the decoded signal into image areas;
estimating second correlation data for each of the image areas determined in said subdividing, the second correlation data indicating an autocorrelation of the decoded signal;
calculating a filter coefficient for each of the image areas using the first correlation data and the second correlation data; and
filtering the decoded signal for each of the image areas, using the filter coefficient calculated in said calculating.

8. The image decoding method according to claim 7,
wherein at least one of a deblocking filter process, a post filter process, and an interpolation filter process is performed in said filtering, the deblocking filter process being for reducing blocking artifacts occurring in a boundary between the blocks that are adjacent to each other, the post filter process being for improving a subjective image quality of the decoded signal, and the interpolation filter process being for spatially interpolating a pixel value of the decoded signal.

9. An image coding apparatus that codes a signal to be coded that represents an image, said apparatus comprising:
a quantization unit configured to quantize the signal to be coded to determine a quantized coefficient;
an inverse quantization unit configured to inverse quantize the quantized coefficient to generate a decoded signal;
an area forming unit configured to subdivide the decoded signal into image areas;
an estimation unit configured to estimate (i) first correlation data for each area larger than one of the image areas determined by said area forming unit, and (ii) second correlation data for each of the image areas determined by said area forming unit, the first correlation data indicating a correlation between the signal to be coded and the decoded signal, and the second correlation data indicating an autocorrelation of the decoded signal;
a filter coefficient calculation unit configured to calculate a filter coefficient using the first correlation data and the second correlation data for each of the image areas;
a filtering unit configured to filter the decoded signal for each of the image areas, using the filter coefficient calculated by said filter coefficient calculation unit; and
an output unit configured to provide only the first correlation data from the first correlation data and the second correlation data.

10. An image decoding apparatus that decodes a coded signal, said apparatus comprising:
an obtaining unit configured to obtain a quantized coefficient, and first correlation data indicating a correlation between a signal to be coded and a decoded signal;
an inverse quantization unit configured to inverse quantize the quantized coefficient to generate the decoded signal;
an area forming unit configured to subdivide the decoded signal into image areas;
an estimation unit configured to estimate second correlation data for each of the image areas determined by said area forming unit, the second correlation data indicating an autocorrelation of the decoded signal;
a filter coefficient calculation unit configured to calculate a filter coefficient for each of the image areas using the first correlation data and the second correlation data; and
a filtering unit configured to filter the decoded signal for each of the image areas, using the filter coefficient calculated by said filter coefficient calculation unit.

11. A system comprising:
an image coding apparatus that codes a signal to be coded that represents an image; and
an image decoding apparatus that decodes a coded image,
said image coding apparatus including:
a quantization unit configured to quantize the signal to be coded to determine a quantized coefficient;
a first inverse quantization unit configured to inverse quantize the quantized coefficient to generate a decoded signal;
a first area forming unit configured to subdivide the decoded signal into image areas;
a first estimation unit configured to estimate (i) first correlation data for each area larger than one of the image areas determined by said first area forming unit, and (ii) second correlation data for each of the image areas determined by said first area forming unit, the first correlation data indicating a correlation between the signal to be coded and the decoded signal, and the second correlation data indicating an autocorrelation of the decoded signal;
a first filter coefficient calculation unit configured to calculate a filter coefficient using the first correlation data and the second correlation data for each of the image areas;
a first filtering unit configured to filter the decoded signal for each of the image areas, using the filter coefficient calculated by said first filter coefficient calculation unit; and
an output unit configured to provide only the first correlation data from the first correlation data and the second correlation data, and
said image decoding apparatus including:
an obtaining unit configured to obtain a quantized coefficient, and the first correlation data indicating the correlation between the signal to be coded and the decoded signal;
a second inverse quantization unit configured to inverse quantize the quantized coefficient to generate the decoded signal;
a second area forming unit configured to subdivide the decoded signal into image areas;
a second estimation unit configured to estimate second correlation data for each of the image areas determined by said second area forming unit, the second correlation data indicating an autocorrelation of the decoded signal;
a second filter coefficient calculation unit configured to calculate a filter coefficient for each of the image areas using the first correlation data and the second correlation data; and
a second filtering unit configured to filter the decoded signal for each of the image areas, using the filter coefficient calculated by said second filter coefficient calculation unit.

12. A program causing a computer to code a signal to be coded that represents an image, said program comprising:
quantizing the signal to be coded to determine a quantized coefficient;
inverse quantizing the quantized coefficient to generate a decoded signal;
subdividing the decoded signal into image areas;
estimating (i) first correlation data for each area larger than one of the image areas determined in said subdividing, and (ii) second correlation data for each of the image areas determined in said subdividing, the first correlation data indicating a correlation between the signal to be coded and the decoded signal, and the second correlation data indicating an autocorrelation of the decoded signal;
calculating a filter coefficient using the first correlation data and the second correlation data for each of the image areas;
filtering the decoded signal for each of the image areas, using the filter coefficient calculated in said calculating; and
providing only the first correlation data from the first correlation data and the second correlation data.

13. A program causing a computer to decode a coded signal, said program comprising:
obtaining a quantized coefficient, and first correlation data indicating a correlation between a signal to be coded and a decoded signal;
inverse quantizing the quantized coefficient to generate the decoded signal;
subdividing the decoded signal into image areas;
estimating second correlation data for each of the image areas determined in said subdividing, the second correlation data indicating an autocorrelation of the decoded signal;
calculating a filter coefficient for each of the image areas using the first correlation data and the second correlation data; and
filtering the decoded signal for each of the image areas, using the filter coefficient calculated in said calculating.

14. An intergraded circuit that codes a signal to be coded that represents an image, said intergraded circuit comprising:
a quantization unit configured to quantize the signal to be coded to determine a quantized coefficient;
an inverse quantization unit configured to inverse quantize the quantized coefficient to generate a decoded signal;
an area forming unit configured to subdivide the decoded signal into image areas;
an estimation unit configured to estimate (i) first correlation data for each area larger than one of the image areas determined by said area forming unit, and (ii) second correlation data for each of the image areas determined by said area forming unit, the first correlation data indicating a correlation between the signal to be coded and the decoded signal, and the second correlation data indicating an autocorrelation of the decoded signal;
a filter coefficient calculation unit configured to calculate a filter coefficient using the first correlation data and the second correlation data for each of the image areas;
a filtering unit configured to filter the decoded signal for each of the image areas, using the filter coefficient calculated by said filter coefficient calculation unit; and
an output unit configured to provide only the first correlation data from the first correlation data and the second correlation data.

15. An intergraded circuit that decodes a coded signal, said intergraded circuit comprising:
an obtaining unit configured to obtain a quantized coefficient, and first correlation data indicating a correlation between a signal to be coded and a decoded signal;
an inverse quantization unit configured to inverse quantize the quantized coefficient to generate the decoded signal;
an area forming unit configured to subdivide the decoded signal into image areas;
an estimation unit configured to estimate second correlation data for each of the image areas determined by said area forming unit, the second correlation data indicating an autocorrelation of the decoded signal;
a filter coefficient calculation unit configured to calculate a filter coefficient for each of the image areas using the first correlation data and the second correlation data; and
a filtering unit configured to filter the decoded signal for each of the image areas, using the filter coefficient calculated by said filter coefficient calculation unit.
